(19) United States
(12) Patent Application Publication
(10) Pub. No.: US 2025/0334827 A1
(43) Pub. Date: Oct. 30, 2025

(54) SIGNAL PROCESSING WITH OPTICAL RESONATORS AND MODULATION ELEMENTS, AND SYSTEMS AND METHODS EMPLOYING SUCH PROCESSING

(71) Applicants: UNIVERSITY OF MARYLAND, COLLEGE PARK, College Park, MD (US); NORTHROP GRUMMAN SYSTEMS CORPORATION, Falls Church, VA (US)

(72) Inventors: Carlos A. RIOS OCAMPO, Hyattsville, MD (US); Niloy ACHARJEE, Hyattsville, MD (US); Siddhartha GHOSH, Falls Church, VA (US)

(21) Appl. No.: 19/190,494

(22) Filed: Apr. 25, 2025

Related U.S. Application Data
(60) Provisional application No. 63/639,418, filed on Apr. 26, 2024.

(51) Int. Cl. G02F 1/01

(52) U.S. Cl. CPC G02F 1/0147

(57) ABSTRACT

A system for optical processing can include an array of optical resonators and a plurality of modulation elements. Resonances of the optical resonators can be detuned from a first wavelength by different phase shifts. Each optical resonator can receive a respective first input optical signal. Each modulation element can be associated with a respective optical resonator of the array. Each modulation element can introduce a phase shift to the respective optical resonator such that the respective first input optical signal is synchronously output from the array in response to the introduced phase shift compensating for the detuned phase shift of the respective optical resonator.

### CROSS-REFERENCE TO RELATED APPLICATIONS

The present application claims the benefit of and priority under 35 U.S.C. § 119 (e) to and is a non-provisional of U.S. Provisional Application No. 63/639,418, filed Apr. 26, 2024, entitled “Photonic Analog-to-Digital Converter,” which is hereby incorporated by reference herein in its entirety.

### FIELD

The present disclosure relates generally to signal processing, and more particularly, to signal processing systems and methods employing optical resonators and modulation elements, for example, for use in analog-to-digital conversion and/or in neuromorphic computing.

### BACKGROUND

Analog-to-digital conversion is often used to interface an analog signal with a digital processing system, such as a digital computer. Conventional analog-to-digital converters (ADCs) can face performance limitations, in particular, a trade-off between sampling speed and resolution. For example, as signal frequencies increase (e.g., into the gigahertz range), electronic ADCs may suffer from increased power consumption, aperture jitter, and/or comparator ambiguity, which may limit their performance. Performance limitations may also arise when employing electronic signal processing elements for neuromorphic computing, for example, due to interconnect bandwidth limitations (e.g., von Neumann bottleneck) and/or power consumption. Embodiments of the disclosed subject matter may address one or more of the above-noted problems and disadvantages, among other things.

### SUMMARY

Embodiments of the disclosed subject matter provide systems and methods for signal processing using optical resonators and modulation elements. Each modulation element can be associated with one of the optical resonators, and the optical resonators can have different initial resonance conditions. Respective interactions between an input analog signal and the modulation elements alters the resonant conditions of the optical resonators, such that an optical signal is synchronously output from one of the optical resonators (or a predetermined set of the optical resonators) based on a matched resonance condition. The output can be used to convert the input analog signal to a corresponding digital signal, or for any other purpose, such as but not limited to neuromorphic computing.

In one or more embodiments, a system can comprise an array of optical resonators and a plurality of modulation elements. The resonances of the optical resonators can be detuned from a first wavelength by different phase shifts. Each optical resonator can be constructed to receive a respective first input optical signal. Each modulation element can be associated with a respective optical resonator of the array. Each modulation element can be constructed to introduce a phase shift to the respective optical resonator such that the respective first input optical signal is output from the array in response to the introduced phase shift compensating for the detuned phase shift of the respective optical resonator.

In one or more embodiments, a method can comprise providing an array of optical resonators and a plurality of modulation elements. Resonances of the optical resonators can be detuned from a first wavelength by different phase shifts, and each modulation element can be associated with a respective optical resonator of the array. The method can further comprise providing a plurality of first input optical signals to the array of optical resonators, respectively. The method can also comprise introducing, for each optical resonator, a respective phase shift via the associated modulation element. The method can further comprise outputting, from the array at a predetermined time with respect to the providing the plurality of first input optical signals, the respective first input optical signal in response to the introduced phase shift compensating for the detuned phase shift of the respective optical resonator.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

Embodiments will hereinafter be described with reference to the accompanying drawings, which have not necessarily been drawn to scale. Where applicable, some elements may be simplified or otherwise not illustrated in order to assist in the illustration and description of underlying features. Throughout the figures, like reference numerals denote like elements.

FIG. 1A is a simplified schematic diagram illustrating aspects of a signal processing system, according to one or more embodiments of the disclosed subject matter.

FIG. 1B is a simplified schematic diagram illustrating aspects of a 2-bit photonic analog-to-digital converter (ADC), according to one or more embodiments of the disclosed subject matter.

FIG. 1C is a simplified schematic diagram illustrating aspects of a 2-bit photonic ADC employing a temporal multiplexer for the optical signal output, according to one or more embodiments of the disclosed subject matter.

FIG. 1D is a simplified schematic diagram illustrating aspects of a 2-bit photonic ADS employing a temporal multiplexer for the optical signal input, according to one or more embodiments of the disclosed subject matter.

FIG. 1E is a simplified schematic diagram illustrating aspects of an optical processing system with tunable resonators, according to one or more embodiments of the disclosed subject matter.

FIG. 2A is a simplified schematic diagram illustrating aspects of a 2-bit photonic integrated ADC with ring resonators and thermo-optic modulation elements, according to one or more embodiments of the disclosed subject matter.

FIG. 2B is a simplified schematic diagram illustrating aspects of a 3-bit photonic integrated ADC with ring resonators and thermo-optic modulation elements, according to one or more embodiments of the disclosed subject matter.

FIG. 2C is a simplified schematic diagram illustrating aspects of a 3-bit photonic integrated ADC employing a temporal multiplexer for the optical signal output, according to one or more embodiments of the disclosed subject matter.

FIG. 2D is a simplified schematic diagram illustrating aspects of a 3-bit photonic integrated ADC employing a dual optical input, according to one or more embodiments of the disclosed subject matter.

FIG. 3A shows a configuration of a ring resonator and thermo-optic modulation element employed in a simulation of light transmission.

FIGS. 3B-3C show the simulation results for modulation of light transmission in the setup of FIG. 3A at different temperatures.

FIG. 4 is a simplified schematic diagram illustrating aspects of a signal processing system with modulation elements as part of optical resonators, according to one or more embodiments of the disclosed subject matter.

FIG. 5A is a simplified schematic diagram illustrating aspects of a 3-bit photonic integrated ADC with thermo-optic modulation elements in Fabry-Perot resonators, according to one or more embodiments of the disclosed subject matter.

FIG. 5B shows simulation results for modulation of light transmission from a Fabry-Perot resonator via a Ge—Sb—Te alloy thermo-optic modulation element.

FIG. 6A is a simplified schematic diagram illustrating aspects of a signal processing system with optical resonators arranged in parallel and modulation elements that respond to an electrical input signal, according to one or more embodiments of the disclosed subject matter.

FIG. 6B is a simplified schematic diagram illustrating aspects of another signal processing system with optical resonators arranged in series and modulation elements that respond to an electrical input signal, according to one or more embodiments of the disclosed subject matter.

FIG. 7A is a simplified schematic diagram illustrating aspects of a 3-bit photonic integrated ADC with parallel-arranged ring resonators and modulation elements responsive to an electrical input signal, according to one or more embodiments of the disclosed subject matter.

FIG. 7B is a simplified schematic diagram illustrating aspects of a 4-bit photonic integrated ADC with parallel-arranged ring resonators and modulation elements responsive to an electrical input signal, according to one or more embodiments of the disclosed subject matter.

FIG. 7C is a simplified schematic diagram illustrating aspects of a 2-bit photonic integrated ADC with serial-arranged ring resonators and modulation elements responsive to an electrical input signal, according to one or more embodiments of the disclosed subject matter.

FIG. 8A shows a simplified schematic of an experimental setup for a 2-bit photonic integrated ADC, according to one or more embodiments of the disclosed subject matter.

FIG. 8B shows the various outputs at the respective drop ports for 50-μs input pulses of different magnitudes (i.e., 500 mV, 900 mV, and 1180 mV) in the ADC setup of FIG. 8A.

FIGS. 8C-8E show the wavelength spectrum output from each ring in response to the input pulses of different magnitudes (i.e., 500 mV, 900 mV, and 1180 mV), respectively, in the ADC setup of FIG. 8A.

FIG. 9A is a process flow diagram illustrating aspects of a method for signal processing, according to one or more embodiments of the disclosed subject matter.

FIG. 9B depicts a generalized example of a computing environment in which the disclosed technologies may be implemented.

### DETAILED DESCRIPTION

### General Considerations

For purposes of this description, certain aspects, advantages, and novel features of the disclosed subject matter are described herein. The disclosed methods and systems should not be construed as being limiting in any way. Instead, the present disclosure is directed toward all novel and nonobvious features and aspects disclosed herein, alone and in various combinations and sub-combinations with one another. The methods and systems are not limited to any specific aspect or feature or combination thereof, nor do the disclosed aspects require that any one or more specific advantages be present, or problems be solved. The technologies from any aspect or example can be combined with the technologies described in any one or more of the other aspects or examples. In view of the many possible aspects to which the principles of the disclosed technology may be applied, it should be recognized that the illustrated aspects of the disclosure are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one skilled in the art.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person skilled in the art to have a more definitive construction, the numerical parameters set forth are approximations that may depend on the desired properties sought and/or limits of detection under standard test conditions/methods, as known to those skilled in the art. When directly and explicitly distinguishing aspects from discussed prior art, the numbers are not approximates unless the word “about,” “substantially,” or “approximately” is recited. Whenever “substantially,” “approximately,” “about,” or similar language is explicitly used in combination with a specific value, variations up to and including 10% of that value are intended, unless explicitly stated otherwise.

Directions and other relative references may be used to facilitate discussion of the drawings and principles herein but are not intended to be limiting. For example, certain terms may be used such as “inner,” “outer,” “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated aspects. Such terms are not, however, intended to imply absolute relationships, positions, and/or orientations. For example, with respect to an object, an “upper” part can become a “lower” part simply by turning the object over. Nevertheless, it is still the same part, and the object remains the same.

As used herein, “comprising” means “including,” and the singular forms “a” or “an” or “the” include plural references unless the context clearly dictates otherwise. The term “or” refers to a single element of stated alternative elements or a combination of two or more elements unless the context clearly indicates otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined below can be substituted or unsubstituted.

Unless explained otherwise, all technical and scientific terms used herein have the same meaning as commonly understood to one skilled in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Features of the presently disclosed subject matter will be apparent from the following detailed description and the appended claims.

### INTRODUCTION

Disclosed herein are novel signal processing systems employing an array of optical resonators and modulation elements that allow an optical signal to be selectively output from one optical resonator of the array (or more than one resonator, for example, a predetermined subset) based on interaction of an input analog signal (e.g., optical or electrical signal) with the modulation elements. In some embodiments, an optical system (e.g., a photonic circuit comprising one or more waveguides and/or optical components operating in free space) can convert the optical output signal into a digital optical signal (e.g., an n-bits, where n≥2), and/or one or more photodetectors can convert the optical signal (e.g., after digitization by the photonic circuit or otherwise) into an electrical signal. In some embodiments, a system employing the optical resonators and modulation elements can function as and/or be part of an analog-to-digital converter (ADC) with respect to the input analog signal and/or a neuromorphic computing element (e.g., neuron or part of a hidden layer).

In some embodiments, each of the optical resonators in the array can have a different resonance condition. For example, in some embodiments, each optical resonator can be detuned from a reference resonance (λ₁) by integer multiples of a phase constant (δ). In some embodiments, the modulation element is modulated by interaction with the input analog signal, for example, to change a refractive index (n) of the modulation element. The modulation by the modulation element in turn modulates the resonance condition of the respective optical resonator, for example, to introduce a phase shift to the resonator. When the modulation by the modulation element compensates for the detuning of the resonance of one of the optical resonators, light (e.g., an analog optical signal) can be passed to the output via the optical resonator. Otherwise, the remaining optical resonators of the array prevent transmission of the light to the output due to the detuned resonance (or at least provide light output that is out of sync with the timing of the input signal). In some embodiments, the particular optical resonator from which light is output can provide a measure or indication of the input analog signal (e.g., a magnitude of the amplitude of a pulse).

In some embodiments, the system is constructed as an integrated photonic device, for example, using a silicon-on-insulator (SOI) platform. For example, an all-photonic ADC according to some embodiments of the disclosed subject matter can offer high-speed optical signal conversions, which may further enable next-generation optical computing and communication systems. In contrast to conventional electronic-based ADCs, an all-photonic ADC according to embodiments of the disclosed subject matter can perform conversion entirely in the optical domain, which can reduce power consumption, increase processing speed, and/or eliminate complexity associated with electronic-to-optical conversions.

### Input Optical Signal Processing Examples

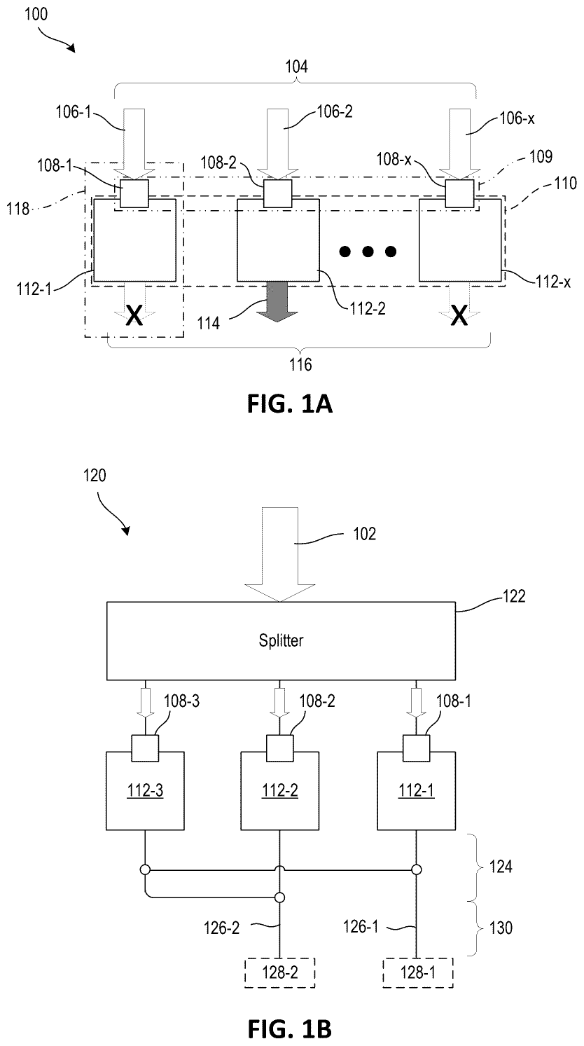

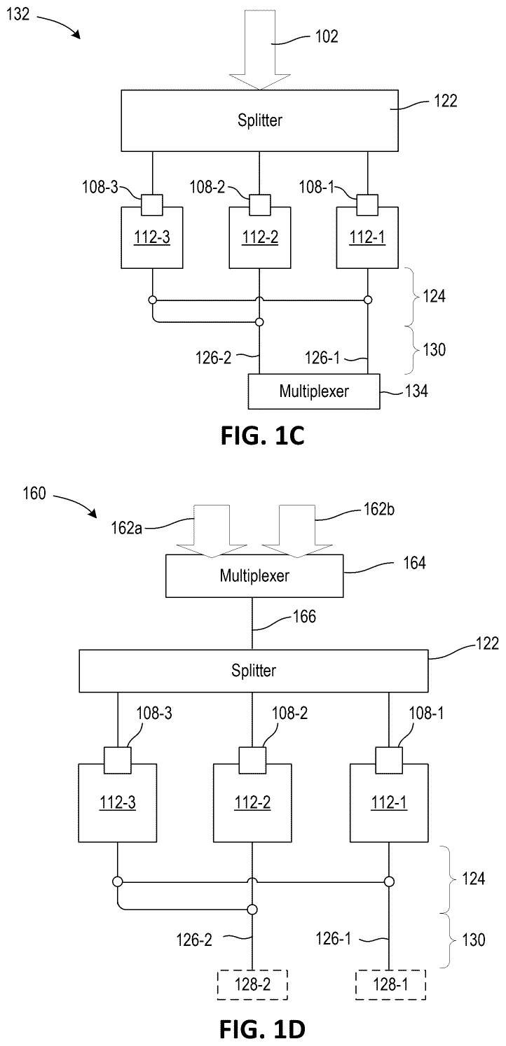

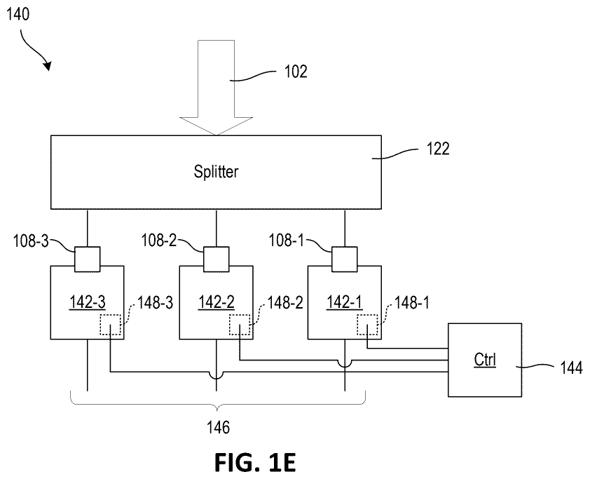

In some embodiments, the input analog signal can be an optical signal, and the output from the array of resonators can be a portion of the input optical signal. For example, FIG. 1A illustrates a processing system 100 having an array 110 of optical resonators 112-1, 112-2, . . . 112-x (where x represents an integer greater than 1), and a plurality 109 of modulation elements 108-1, 108-2, . . . 108-x, with each modulation element being associated with a respective one of the optical resonators. In some embodiments, one, some, or each of the optical resonators in the array 110 can be and/or comprise a ring resonator. Alternatively, in some embodiments, one, some, or each of the optical resonators in the array 110 can be and/or comprise a Fabry-Perot resonator (e.g., employing distributed Bragg reflectors). Other optical resonators are also possible according to one or more contemplated embodiments. Although shown as separate elements in FIG. 1A, each optical resonator can instead comprise and/or a part thereof form the associated modulation element, according to one or more contemplated embodiments of the disclosed subject matter.

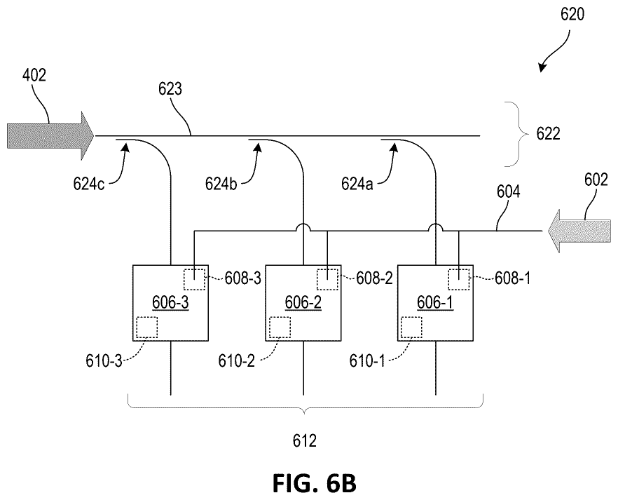

In the illustrated example, processing system 100 is configured with a parallel input arrangement 104, such that each optical resonator receives a respective input optical signal 106-1, 106-2, . . . 106-x at substantially the same time and of substantially equal power. For example, input optical signals 106-1, 106-2, . . . 106-x can be substantially equal portions split from a common input optical signal. Alternatively, in some embodiments, a processing system can be configured with a series input arrangement, such that each optical resonator receives a respective input optical signal 106-1, 106-2, . . . 106-x at different times (e.g., in sequence) and/or of different portions, for example, as shown and described with respect to FIG. 6B. In some embodiments, input optical signals 106-1, 106-2, . . . 106-x can be divided by a splitter into equal fractions based on the number of resonators in array 110. For example, the splitter can be a multimode interferometer or a cascaded Mach-Zehnder switching network. Alternatively, the splitter can be any photonic integrated circuitry (PIC) or other optical setup that allows splitting of an input optical signal into the parallel arrangement 104 of input optical signals 106-1, 106-2, . . . 106-x.

In the illustrated example of FIG. 1A, the input optical signals 106-1, 106-2, . . . 106-x (e.g., at a first wavelength, λ₁) are respectively directed to and interact with modulation elements 108-1, 108-2, . . . 108-x, such that the modulation element 108 is modulated by interaction with the optical portion 106 passing therethrough. The modulation element 108 in turn modulates the respective optical resonator 112, for example, to introduce a phase shift to the respective optical resonator 112 that is proportional to the power of the input optical signal 106. After interacting with the associated modulation element, or at a same time as the interacting, the input optical signals 106-1, 106-2, . . . 106-x can be transmitted to and/or interact with the respective optical resonators 112-1, 112-2, . . . 112-x, each of which can have a different resonance condition. For example, each resonator can be detuned from a reference wavelength (e.g., the first wavelength, λ₁) by different phase shifts.

In some embodiments, each optical resonator is detuned from the reference resonant wavelength by a different integer multiple, x (e.g., equal to the number of resonators, N, in the array 110), of a phase constant, δ (e.g., chosen based on the strength of the modulation by modulation elements 108), for example, e.g., such that the resonance of resonator 112-x is equal to λ₁−x·δ. As such, only the optical resonator 112 whose detuned resonance condition has been compensated by the introduced phase shift will be activated and thereby allow the respective input optical signal 106 to pass to the output 116. In some embodiments, if the detuned resonance condition of a resonator has not been compensated by the introduced phase shift, the resonator may still pass an optical signal to the output, but such signal may be outside of a predetermined time window with respect to the input signal(s) (e.g., overshifted such that it does not coincide with the end of an input pulse, and thus is out of sync with the frequency of the input signal). In the illustrated example of FIG. 1A, the detuned resonance condition of the second optical resonator 112-2 is compensated by the phase shift introduced by modulation element 108-2 responsive to the interaction with input optical signal 106-2, such that only output signal 114 (e.g., also at the first wavelength, λ₁) is transmitted from the second optical resonator 112-2.

Alternatively or additionally, in some embodiments, the different resonant conditions (e.g., dephasing) for the optical resonators in array 110 can be selected to respond to a particular input signal, for example, for use in neuromorphic computing. For example, each combination of optical resonator 112 and modulation element 108 can serve as an optical neuron 118 (or other component in an optical neural network, such as part of a hidden layer) in a neuromorphic computing architecture, where the neuron 118 is only active if the correct information (e.g., codified in amplitude of the input optical signal) is its input. The learning/training process for processing system 100 can involve, for example, tuning of the dephasing of each resonator 112 to respond to the desired input. In such embodiments, the dephasing does not need to be multiples of a constant but rather any dephasing that matches only a desired or predetermined input.

In some embodiments, the modulation element can comprise a thermo-optic material that has a strong thermo-optic coefficient (e.g., the real part of its refractive index depends strongly on temperature) at the wavelength of light passing therethrough (e.g., λ₁) and that absorbs at the wavelength of light passing therethrough (e.g., λ₁). This combination of properties allows the modulation element 108 to heat up under the incidence of the respective input optical signal 106 due to the power absorbed, and the heat in turns triggers a strong optical modulation due to the strong thermo-optic coefficient (e.g., an absolute value of at least 1×10⁻⁴ K⁻¹) of the thermo-optic material. In some embodiments, this modulation can occur without applying any external stimulus besides the input optical signals carrying the information, and thus may be considered “passive” processing of the input signal(s).

Table 1 shows thermo-optic coefficients for exemplary thermo-optic materials that can be used in the processing systems according to one or more embodiments of the disclosed subject matter. In some embodiments, the thermo-optic material has a thermo-optic coefficient of at least 5×10⁻⁴ K⁻¹, such as Ge—Sb—Te alloys or the element Ge. Other materials that exhibit both a strong thermo-optic coefficient and light absorption at the wavelength of interest are also possible according to one or more contemplated embodiments, such as but not limited to Sb—Te, Ge—Sb—Se, and Al—In—Sb—Te. Thermo-optic (TO) responses can be decomposed in two contributions: electronic and lattice (phononic). The lattice contribution is stronger but slower (e.g., ˜kHz-MHz modulations), while the electronic contribution is weaker but faster (e.g., on the order of picoseconds, allowing for GHz modulations). However, embodiments of the disclosed subject matter can exploit either or both contributions, for example, depending on pulse width in the input signal (e.g., the original optical signal from which input optical signals 106 are formed) and/or input power (e.g., the original optical signal and/or input optical signals 106).

TABLE 1
Thermo-optic materials

| | Thermo-optic coefficient |
|---|---|
| Material | (dn/dT) (K⁻¹) |
| Amorphous Ge—Sb—Te alloy (a-GST) | (4.53 ± 0.46) × 10⁻³ |
| Crystalline Ge—Sb—Te alloy (c-GST) | −(2.11 ± 0.36) × 10⁻³ |
| Ge | 7 × 10⁻⁴ |
| Si | 1.8 × 10⁻⁴ |
| SiN | (2.45 ± 0.09) × 10⁻⁵ |
| SiOx | (0.95 ± 0.10) × 10⁻⁵ |
| Indium tin oxide (ITO) | 1.9 × 10⁻⁵ |
| LiNb | nₒ: −0.02 × 10⁻⁵ |
| | n_{c}: 3.2 × 10⁻⁵ |

Alternatively, in some embodiments, the modulation element can comprise a metal-to-insulator material (e.g., VO₂) that can experience a volatile phase transition when heated. In such embodiments, the modulation element 108 can be heated by the respective input optical signal 106 passing therethrough, such that the metal-to-insulator material experiences a solid phase transition (e.g., from amorphous to crystalline), which in turn changes a refractive index of the material and introduces a phase shift to the light passing therethrough. Alternatively, in some embodiments, the modulation element can comprise an optical nonlinearity material, such as an optical Kerr nonlinearity material. Other materials whose optical properties can be modulated by the incidence of input optical signals 106 are also possible for the modulation element according to one or more contemplated embodiments.

In the illustrated example of FIG. 1A, each input optical signal 106-1, 106-2, . . . 106-x can be derived (e.g., equal fraction of) from a single input optical signal, and thus each may have the same wavelength. However, in some embodiments, multiple optical signals at different wavelengths may be provided for simultaneous or sequential process. For example, several signals can be multiplexed at different wavelengths (e.g., λ₁+λ₂+λ₃) and provided as input to the processing system 100, as long as λ_{y}=y×FSR+λ₁, where y is the number of wavelengths multiplexed and FSR is the free-spectral range of the optical resonators. In some embodiments, a demultiplexer may be used at output 116, for example, if the signals are processed simultaneously.

In the illustrated example of FIG. 1A, the optical signal 114 is selected as the output 116 from the array 110 of optical resonators 112, which output signal can be used by a subsequent photonic system and/or converted to an electrical signal (e.g., detected by a photodetector). Alternatively or additionally, in some embodiments, the output 116 can be routed to generate an n-bit output, for example, to convert an analog optical signal (e.g., used to generate the individual input optical signals 106) to a corresponding digital signal (e.g., optical or electrical). For example, FIG. 1B illustrates a photonic analog-to-digital converter 120 (ADC) for converting input optical signal 102 to a 2-bit output indicative of a pulse amplitude of the input optical signal 102. Similar to processing system 100, the ADC 120 of FIG. 1B includes an array of three modulation elements 108-1 through 108-3, an array of three optical resonators 112-1 through 112-3, and a splitter 122 (e.g., a 1×3 splitter). The input optical signal 102 is divided into three equal portions by splitter 122, which input signal portions then interact with respective modulation elements 108-1, 108-2, 108-3, thereby causing respective phase shifts in respective optical resonators 112-1, 112-2, 112-3 (e.g., detuned according to λ₁−x·δ, where x is the number of the resonator in the array).

As with processing system 100, only the optical resonator 112-1, 112-2, 112-3 whose detuning is compensated and aligns with that of the input optical signal portion will be activated and thus allow the light to pass. In the illustrated example of FIG. 1B, the ADC 120 is additionally provided with a photonic routing circuit 124 that routes the light from the array of optical resonators 112 (e.g., to passively indicate from which optical resonator light was output), for example, to build an n-bit digital output signal. For example, photonic routing circuit 124 can include any combination of waveguides, power splitters, power combiners, waveguide crossings, escalators (e.g., to provide a 3-D waveguide configuration that avoids crossings), and/or free space optical components to route the light from each resonator 112-1, 112-2, 112-3 to output region 130.

In the illustrated example of FIG. 1B, the input optical signal 102 is converted into a 2-bit digital output. The output region 130 can have a first output waveguide 126-1 that corresponds to a first bit and a second output waveguide 126-2 that corresponds to a second bit, with each bit corresponding to a power in the binary basis. Depending on the combination of waveguides 126-1, 126-2 that are activated in the output region 130, a signal or no signal is obtained in each of those output channels, thereby passively obtaining a digital conversion of the input optical signal 102. Although FIG. 1B illustrates a 2-bit architecture, embodiments of the disclosed subject matter are not limited thereto. Rather, the illustrated architecture can be extended to any n-bit conversion by simply using additional optical resonators (and associated modulation elements) and providing a sufficient photonic routing circuit to build the n-bit output. In some embodiments, the number (N) of resonators (and associated modulation elements, as well as the configuration of the splitter to generate respective input optical signal portions) can be N=2·n-1, where n is the desired number of bits for the output.

In some embodiments, the optical signal output from the resonator array (e.g., signal 114 in FIG. 1A), or the digital optical resulting therefrom (e.g., signals carried by waveguides 126-1, 126-2 in FIG. 1B), can be used by a subsequent photonic circuit (e.g., another photonic system 100 or 120, for example, when placed in an array and interconnected together to increase sampling, such as but not limited to 2 ADCs of 3-bits side by side and interconnected to process a higher 4-bit signal) or optical system. Alternatively or additionally, in some embodiments, the optical signal output from the resonator array, or the digital optical signal resulting therefrom, can optionally be converted into an electrical signal, for example, by detection via a respective photodetector 128-1, 128-2, such as but not limited to a photomultiplier tube (PMT), one or more pixels of a charge-coupled device (CCD) or a complementary metal-oxide semiconductor (CMOS) image sensor, a photodiode (e.g., avalanche photodiode), a phototransistor, or a metal-semiconductor-metal photodetector.

Alternatively or additionally, in some embodiments, the digital optical signal (e.g., carried by waveguides 126-1, 126-2 in FIG. 1B) can be consolidated into a single output, for example, by providing ADC 132 with a temporal multiplexer 134, as shown in FIG. 1C. In such embodiments, the binary signal can be codified in a single output but with each bit separated in time. Alternatively or additionally, in some embodiments, multiplexing can be applied to processing of multiple input optical signals 162a, 162b (e.g., having the same or different wavelengths), for example, by providing ADC 160 with a temporal multiplexer 164 for sequentially providing input 166 to splitter 122, as shown in FIG. 1D.

As described above with respect to FIGS. 1A-ID, each optical resonator can have a different resonant condition (e.g., dephasing at multiples of a constant for ADC operation, or dephasing selected to be responsive to a particular input for neuromorphic computing). In some embodiments, the different resonant conditions can be set (e.g., resonator detuned) during fabrication or after fabrication of the resonator. For example, the detuning can be performed using solid phase change materials, ion implantation, polymers, ferroelectric materials, or any other known trimming technique. Alternatively or additionally, in some embodiments, the resonant conditions can be set in a volatile manner using active phase shifters (e.g., thermo-optic, electro-optic, magneto-optic, liquid-crystal, Kerr nonlinearities, etc.), for example, detuning elements 148-1, 148-2, 148-3 within respective resonator 142-1, 142-2, 142-3, as shown by photonic system 140 of FIG. 1E. In some embodiments, controller 144 can actively modify the dephasing introduced by elements 148-1 through 148-3, for example, to yield a particular output at output region 146 responsive to a target input optical signal (e.g., signal 102, as part of a learning process). For example, the configuration of photonic system 140 can be adapted for neuromorphic computing or as part of an optical neural network.

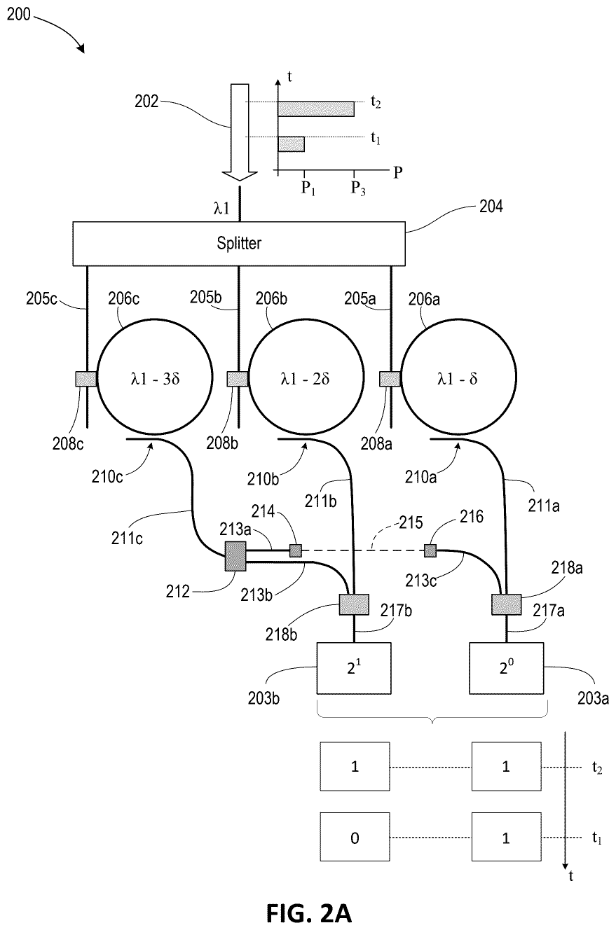

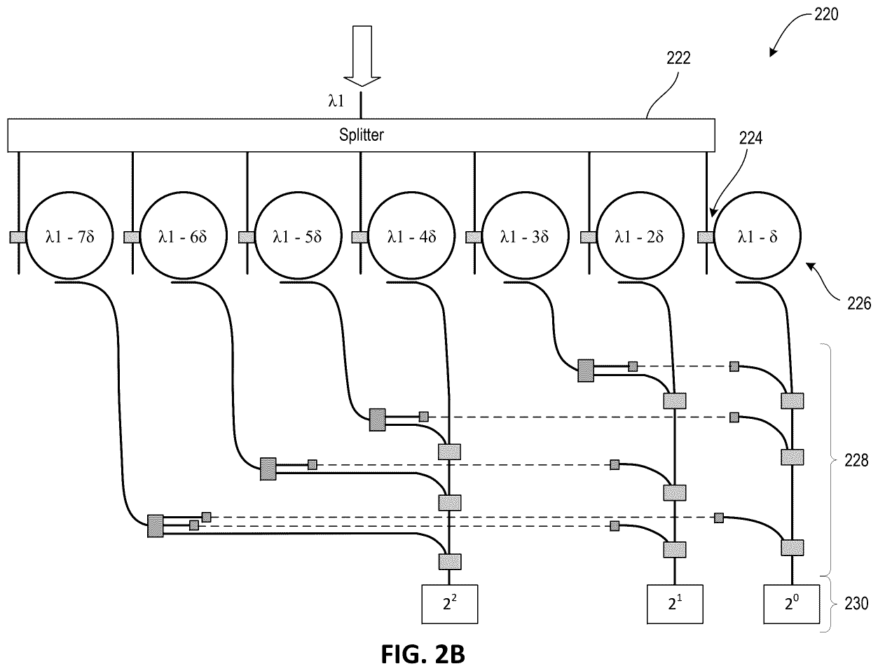

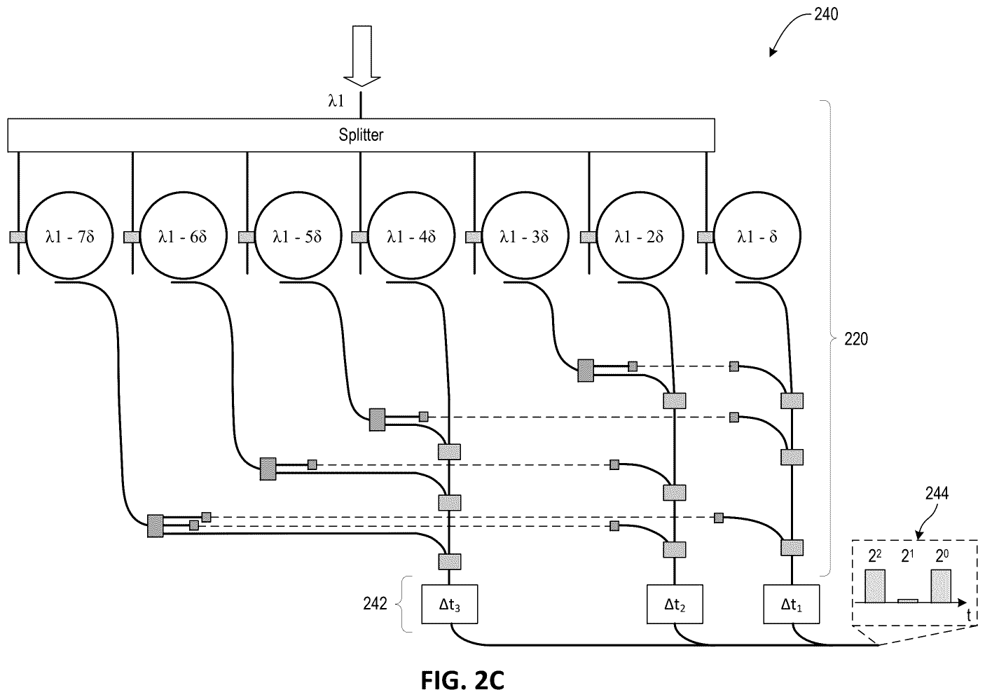

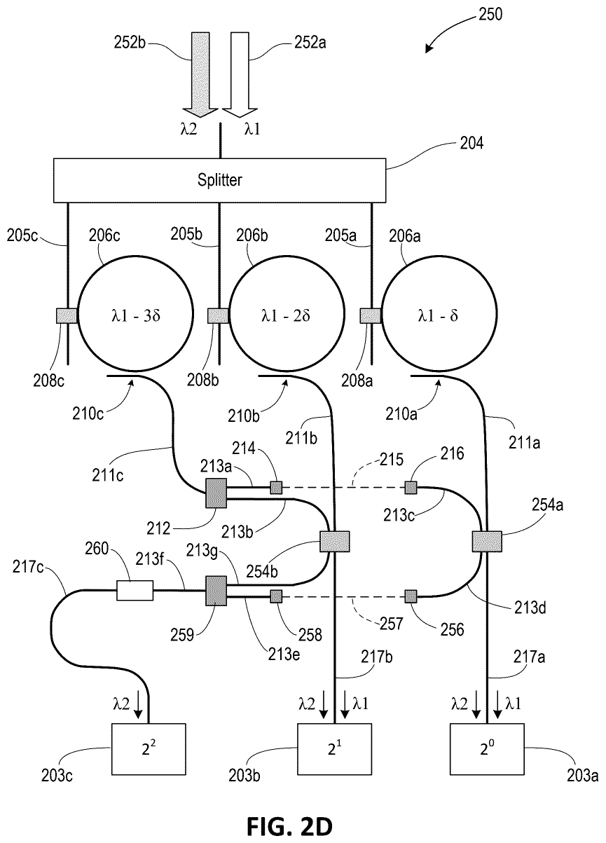

FIG. 2A shows an exemplary configuration of a 2-bit photonic integrated ADC 200 employing three ring resonators 206a, 206b, 206c. In the illustrated example, an input optical signal 202 (e.g., having temporally-separated pulses, codified in a wavelength, λ₁, of amplitude P₁ and P₃, where P₃=3×P₁) is provided to a 1×3 splitter 204, which splits the signal 202 into three signals of equal power. These separate input optical signals are then respectively provided to waveguides 205a, 205b, 205c for transmission to and interaction with modulation elements 208a, 208b, 208c, and ring resonators 206a, 206b, 206c. The coupling region of each ring resonator 206a, 206b, 206c features an associated modulation element 208a, 208b, 208c, for example, a thermo-optic material deposited on top of the respective waveguide 205a, 205b, 205c conveying the input optical signals from the splitter 204. The modulation that the coupling region undergoes when the optical signal arrives introduces a phase shift proportional to the power of the input signal, which can be characterized in terms of the resonator dephasing constant, δ.

Only the drop port 210a, 210b, 210c of the ring resonator 206a, 206b, 206c whose dephasing is compensated and aligns with A will be activated, thereby allowing the split signal to pass to a routing network (e.g., formed by elements 211-218) configured to form a 2-bit representation of the amplitude of the input signal 202. In the illustrated example, any optical output from drop port 210a is routed to a first output 203a (e.g., corresponding to a first bit) via its first output waveguide 211a, a power combiner 218a, and a fourth output waveguide 217a, while any optical output from drop port 210b is routed to a second output 203b (e.g., corresponding to a second bit) via its first output waveguide 211b, a power combiner 218b, and a fourth output waveguide 217b. In addition, any optical output from drop port 210c is routed to both the first output 203a and the second output 203b via its first output waveguide 211c after being split by power splitter 212 into equal portions. A first portion from drop port 210c is directed from power splitter 212 via a second output waveguide 213a, waveguide crossing or level transfer device 214 (e.g., escalator), third output waveguide 215, another waveguide crossing or level transfer device 216 (e.g., de-escalator), and another second output waveguide 213c to power combiner 218a, where it is then routed to the first output 203a similar to the output from drop port 210c. A second portion from drop port 210c is directed from power splitter 212 via another second output waveguide 213b to power combiner 218b, where it is then routed to the second output 203b similar to the output from drop port 210b. In some embodiments, the input waveguides 205a-c, the first output waveguides 211a-c, the second output waveguides 213a-c, and the fourth output waveguides 217a-b may be considered level-1 optical elements (e.g., formed on a same layer or from a same group of layers), while the third output waveguide 215 may be considered a level-2 optical element (e.g., formed on a layer, or from a group of layers, different than the level-1 optical elements).

The input optical signal 202 is thus converted into a desired 2-bit optical signal at outputs 203a-b. In some embodiments, the optical signal at 203a-b can be converted into an electrical signal, for example, by detection using respective photodetectors. For example, pulse P₁ can activate and be output from the first ring 206a (λ₁−δ), which output is in turn conveyed via the photonic routing circuit to only the first output 203a (2⁰) only at 216, thereby resulting in a “0 1” signal. In contrast, pulse P₃, which has a larger amplitude than P₁, can activate and be output from the third ring (λ₁−3δ), which output is in turn conveyed via the photonic routing circuit to both the first output 203a (2°) and the second output 203b (2¹), thereby resulting in a “1 1” signal. If a pulse having an amplitude between P₁ and P₃ was part of input signal 202, such a pulse would activate and be output from the second ring (λ₁−3δ), which output is in turn conveyed via the photonic routing circuit to only the second output 203b (2¹), thereby resulting in a “1 0” signal. In this manner, the input optical signal can be passively converted to a digital representation, in particular, relying on the interaction between the optical signal, the thermo-optic modulation elements, and the ring resonators to self select an output channel that corresponds to a magnitude of the optical signal.

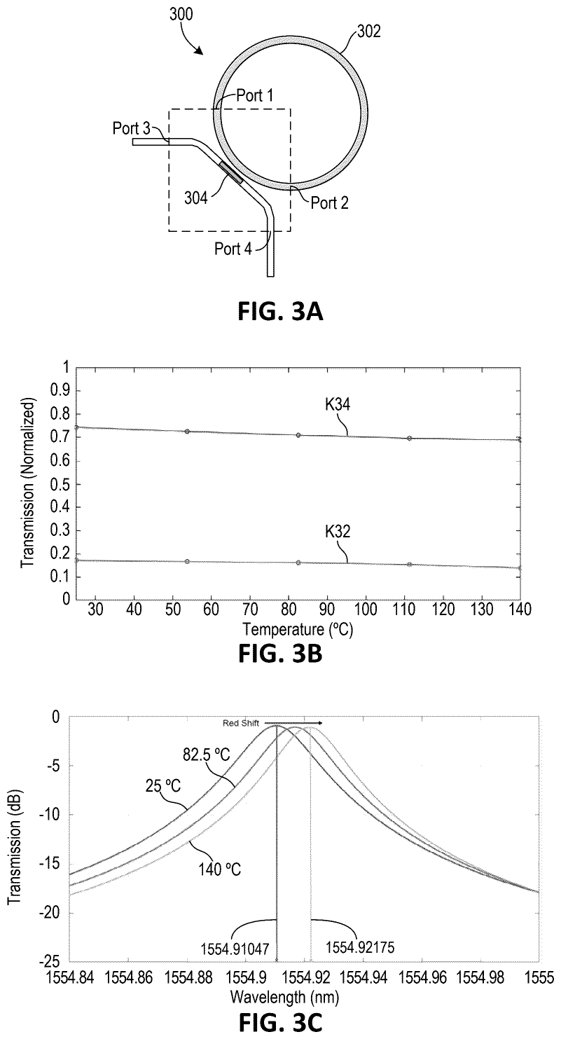

FIGS. 3B-3C and Table 2B below show simulation results for optical transmission as a function of increasing temperature (e.g., due to absorption of an optical pulse by a thermo-optic material) for the setup 300 in FIG. 3A. The setup 300 included a silicon-on-insulator (SOI) ring resonator 302 interacting with thermo-optic modulation element 304, and the details of the construction are reflected in Table 2A below. In some embodiments, the dephasing constant δ can be selected based on the strength of the modulation by the thermo-optic material, for example, as reflected in the data of FIG. 3C.

TABLE 2A
Values of simulation variables for setup of FIG. 3A

| Variable | Value |
|---|---|
| Construction | Silicon-on-insulator (SOI) |
| | 120-nm etched slab waveguide |
| Radius of ring resonator 302 | 20-μm |
| Gap between ring 302 and | 150-nm |
| modulation element 304 | |
| Active material of | Amorphous Ge—Sb—Te alloy (a-GST) |
| modulation element 304 | |
| Thickness of active material | 10-nm |
| Length of active material | 5-μm |

TABLE 2B
Transmittance results for setup of FIG. 3A at different temperatures

| | Transmission | | | |
|---|---|---|---|---|
| Temperature | Port 1 to 2 | Port 3 to 4 | Port 1 to 4 | Port 3 to 2 |
| (° C.) | (K12) | (K34) | (K14) | (K32) |
| 25 | 0.813423 | 0.743285 | 0.172086 | 0.172075 |
| 53.75 | 0.81568 | 0.725424 | 0.167116 | 0.167108 |
| 82.5 | 0.817534 | 0.709569 | 0.162723 | 0.162707 |
| 111.25 | 0.823834 | 0.696135 | 0.154369 | 0.154361 |
| 140 | 0.836794 | 0.688684 | 0.139437 | 0.139425 |

FIG. 2B shows a photonic integrated ADC 220 similar to ADC 200 of FIG. 2A but configured for 3-bit conversion rather than 2-bit conversion. As noted above, the number (N) of resonators (and associated modulation elements) can be a function of the desired number (n) of bits, in particular, N=2ⁿ−1. Thus, the 3-bit ADC 220 of FIG. 2B employs seven thermo-optic modulation elements 224 and associated ring resonators 226 (e.g., detuned at different multiples of phase constants, δ, as shown). A 1×7 splitter 222 can be used to split the input optical signal into seven signals of equal power that are then directed via respective waveguides for interaction with the thermal-modulation elements 224 and ring resonators 226. Photonic routing network 228 can form the output from the array of ring resonators 226 into the desired 3-bit optical signal at 230. Alternatively, in some embodiments, the optical signal at 230 (or the optical signal at 216 in FIG. 2A) can be multiplexed into a single waveguide using a delay lines 242, as shown for system 240 in FIG. 2C. In such embodiments, the binary signal for each bit can be codified in a single output but with each bit separated temporally, as shown at 244 in FIG. 2C. In some embodiments, the temporal multiplexed optical signal can be converted to an electrical signal, for example, using a photodetector.

Although FIGS. 2A-2C only show 2-bit and 3-bit configurations, larger number of bits can be achieved by providing a corresponding number of resonators and modulation elements, as well as appropriate selection of detuning phase constant and design of the photonic routing network, for example, such that N=2ⁿ−1. Alternatively, in some embodiments, the routing circuit can be configured such that the fewer resonators are used to achieve a desired n-bit output, for example, such that N=2ⁿ, as shown for the 3-bit photonic ADC 250 in FIG. 2D. Similar to FIGS. 2A-2C, ADC 250 employs a splitter 204 to split input optical signals into equal portions that are then transmitted via respective waveguides 205a-c for interaction with modulation elements 208a-c and ring resonators 206a-c, whereby appropriate compensation of the resonator tuning allows activation of one of the drop ports 210a-210c. However, in contrast to the examples of FIGS. 2A-2C, a first input optical signal 252a (e.g., having the first wavelength, λ₁), and a second optical signal 252b (e.g., having a second wavelength, λ₂, different than λ₁) are simultaneously input to splitter 204. In addition, the routing circuit has been modified such that: power combiners 218a, 218b are replaced by power combiner/splitter 254a, 254b; additional second output waveguides 213d, 213c, 213f, and 213g, additional level transfer devices 256 and 258, an additional third output waveguide 257, and an additional fourth output waveguide 217c are added; and an optical filter 260 (e.g., a bandpass filter, Bragg grating, or Fabry-Perot resonator), a power combiner 259, and a third output 203c (e.g., corresponding to a third bit) are provided.

The wavelengths λ₁ and λ₂ can be strategically selected such that (1) for intermediate power levels corresponding to digital codes 01, 10, and 11 (e.g., bits 203a-b), the resonant wavelengths of the ring resonators 206a-206c sequentially align with A of the first input optical signal 252a, and (2) at higher power levels, the ring resonators 206a-206c shift their resonance to λ₂ of the second input optical signal 252b so as to encode higher quantization levels. In operation, the output signals corresponding to the two least significant bits (LSBs), representing 2⁰ and 2¹, are optically split (e.g., via power combiner/splitters 254a-b) and recombined (e.g., via power combiner 259) before being directed to filter 260, which is configured to selectively transmit λ₂ but not λ₁, thereby enabling activation of the most significant bit (MSB), corresponding to 2², for example, only when the input signal power exceeds a certain threshold.

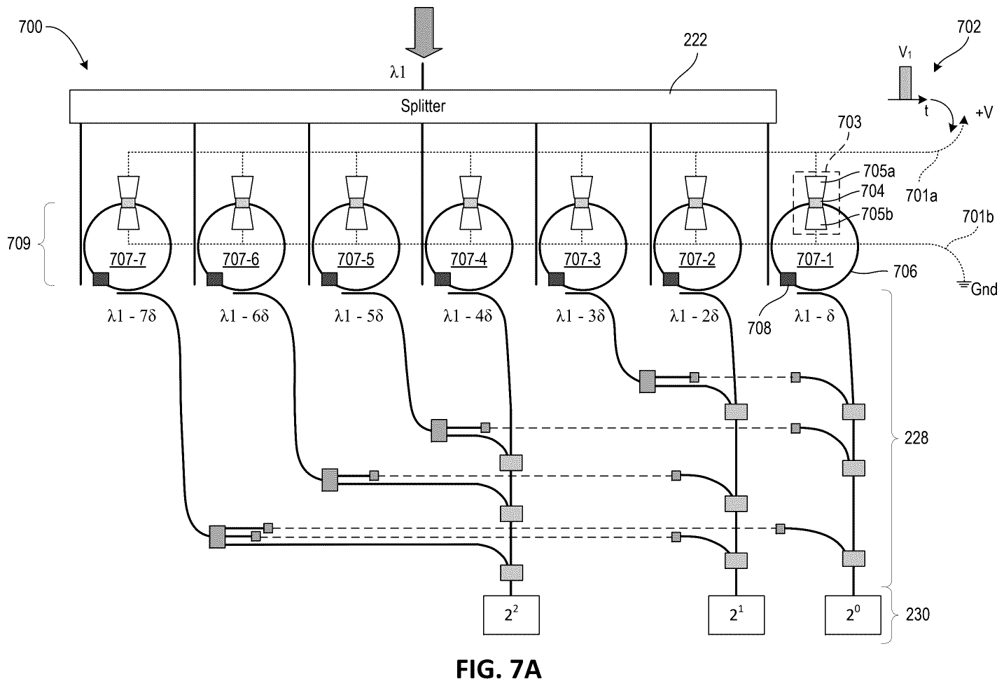

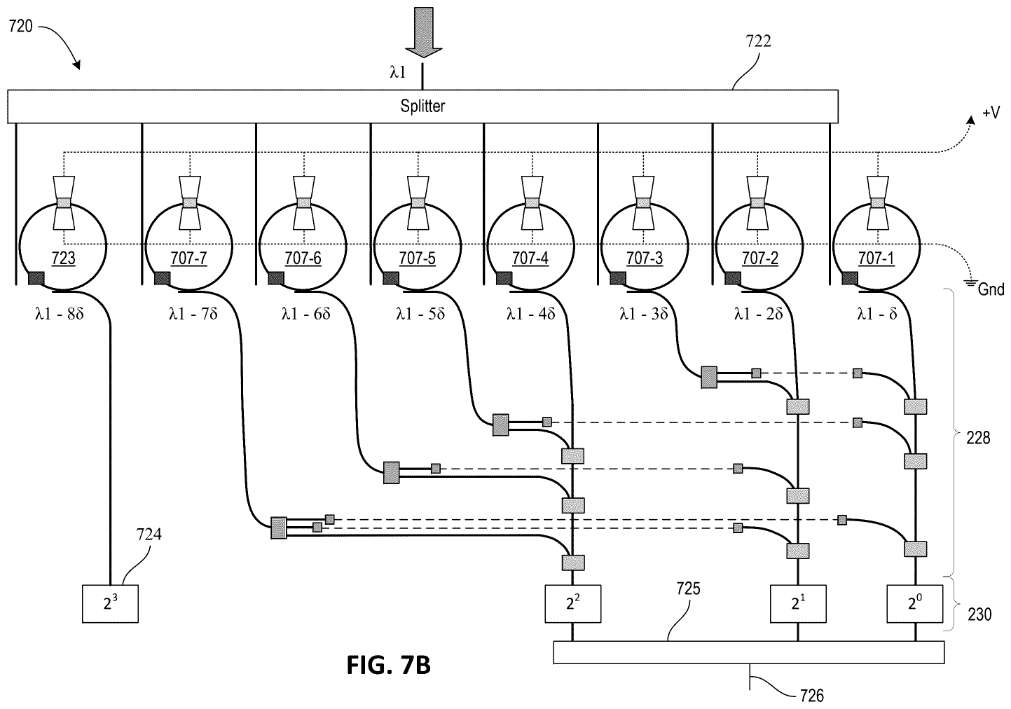

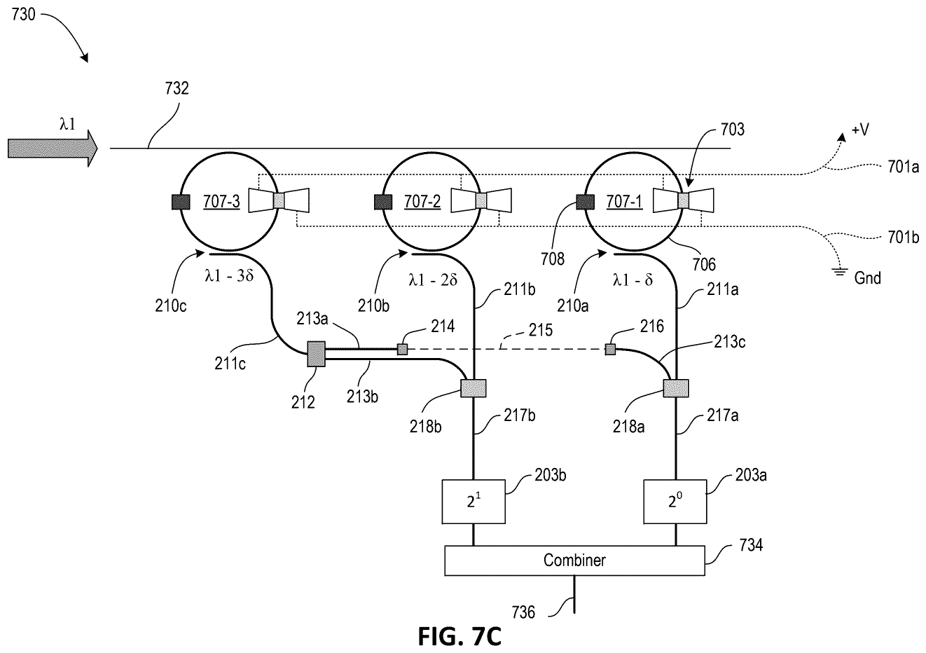

Although only two input wavelengths are described with respect to FIG. 2D, embodiments of the disclosed subject matter are not limited thereto. Rather, in one or more contemplated embodiments, the input can employ as many wavelengths as the free spectral range (FSR) and/or spectral width of the ring resonators may allow. In embodiments using more than two input wavelengths, additional filters may be provided, for example, to separate each wavelength from the others. Although a particular routing circuit and/or output processing technique is shown in FIG. 2D, embodiments of the disclosed subject matter are not limited thereto. Rather, other routing circuits and/or processing techniques are also possible to achieve a desired n-bit configuration with equal to or less than 2n resonators, for example, as shown in FIG. 7B and described in further detail below. Alternatively or additionally, the multiple input wavelength approach illustrated in FIG. 2D can be adapted for use in any of the other processing systems described herein.

Examples of Input Optical Signal Processing with Readout Light

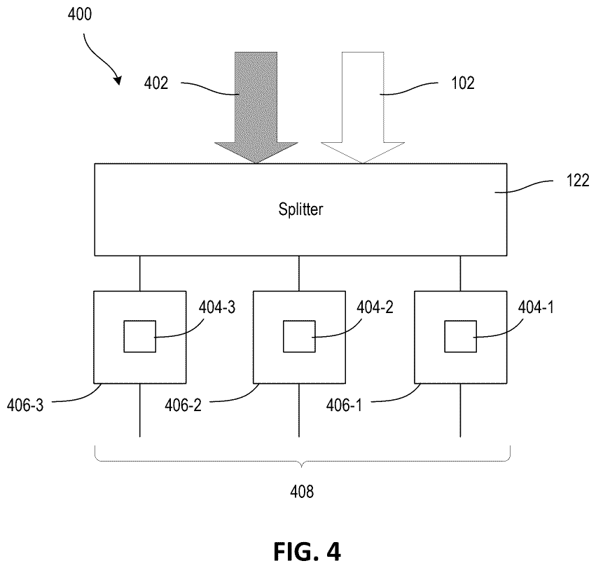

In some embodiments, the input analog signal can be an optical signal, and the output from the array of resonators can be a portion of a different optical signal, for example, a readout light. For example, FIG. 4 illustrates a processing system 400 that receives an input analog optical signal 102 (e.g., at a second wavelength, λ₂) as well as input readout light 402 (e.g., at a first wavelength, λ₁). In some embodiments, the readout light 402 has a constant intensity. Alternatively, the readout light 402 can have a varying intensity, for example, pulses timed to correspond (e.g., coincident or at least partially overlapping in time) with optical signal 102. Similar to the other embodiments described elsewhere herein, the processing system 400 includes a splitter 122, a plurality of modulation elements 404-1, 404-2, 404-3, and an array of optical resonators 406-1, 406-2, 406-3 with different resonance conditions (e.g., λ₁−δ, λ₁−2δ, and λ₁−3δ). However, rather than the output at 408 being a portion of the input optical signal, a portion of the readout light 402 is provided.

For example, the input optical signal 102 and the readout light 402 can be divided by splitter 122 into three substantially equal portions. The portions of the input optical signal 102 can interact with the modulation elements 404-1 through 404-3, which interaction can introduce a phase shift into the optical resonator 406-1 through 406-3. For example, the portions of the input optical signal 102 can be partially or completely absorbed by the modulation elements 404-1 through 404-3, thereby changing a refractive index thereof. The optical resonator 406-1 through 406-3 with resonant condition whose dephasing has been compensated by the phase shift introduced by the modulation elements 404-1 through 404-3 will transmit the portion of the readout light 402 to the output 408, while the other resonators will block transmission.

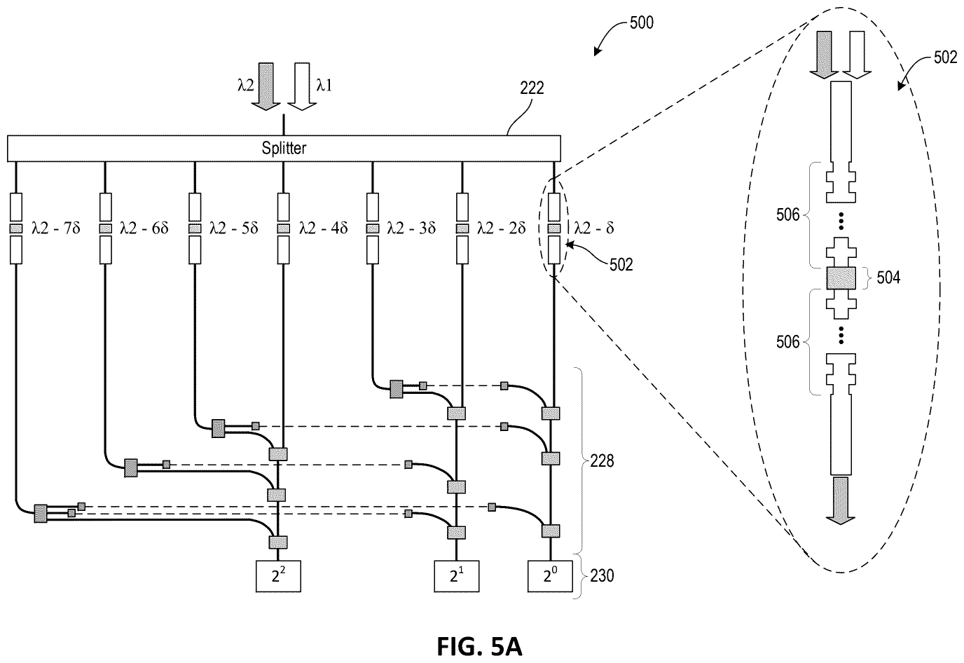

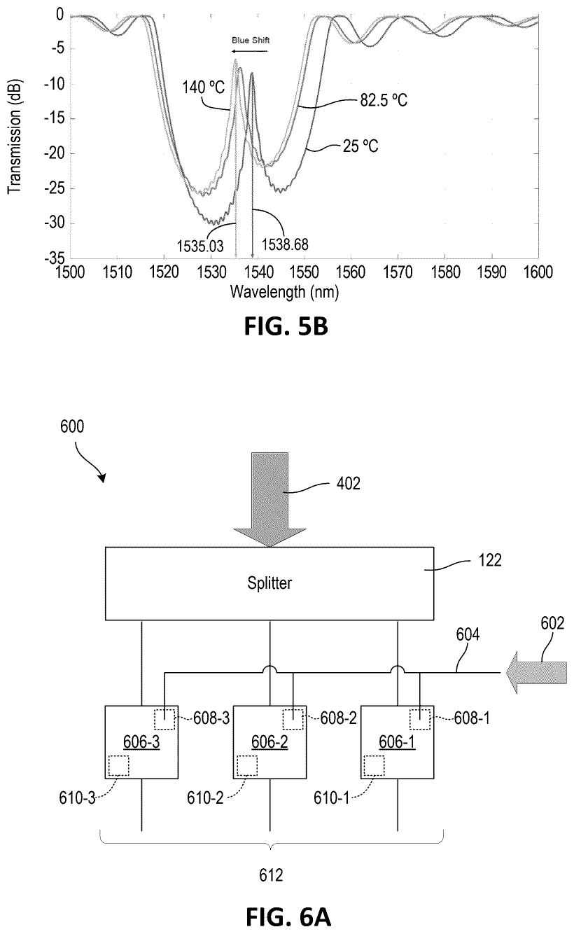

Such a configuration may be useful, but not limited to, when Fabry-Perot resonators are employed. For example, FIG. 5A shows an exemplary configuration of a 3-bit photonic integrated ADC 500 employing seven Fabry-Perot resonators 502 and readout light (at second wavelength, λ₂) for converting input optical signal (at first wavelength, λ₁) into a digital output. Splitter 222 can split each of the input optical signal and the readout light into equal parts, which are then transmitted to respective Fabry-Perot resonators 502 with different resonance conditions (e.g., multiples of a phase constant, δ, selected based on the strength of modulation by the thermo-optic material, for example, as shown in FIG. 5B). Each Fabry-Perot resonator 502 can be formed by a cavity between a pair of Bragg gratings 506, and a thermo-optic modulation element 504 can be provided within or on the cavity. Alternatively or additionally, the thermo-optic element 504 can be part of one or both Bragg gratings 506, or the thermo-optic element 504 can be provided upstream of the Fabry-Perot resonator (e.g., prior to input-side Bragg grating 506).

In some embodiments, each Fabry-Perot resonator 502 can be tuned to have a resonance with respective to the wavelength of the input optical signal (e.g., λ₁), such that the split input optical signal reaches the thermo-optic element 504 in each resonator 502 to induce thermo-optic modulation therein. Depending on the strength of the input optical signal, the modulation may sync with the wavelength of the readout light (e.g., λ₂) to thereby generate the desired output from one of the resonators 502. Alternatively, in some embodiments, each Fabry-Perot resonator 502 can be designed such that the wavelength of the input optical signal (e.g., λ₁) is out of a stop band of the resonator, such that the input optical signal can propagate through the resonator cavity to reach the thermo-optic element 504 and induce thermo-optic modulation therein, for example, to change the phase of the thermo-optic element until it aligns with the wavelength of the readout light (e.g., λ₂). In either case, a photonic routing network 228 (or other optical setup) can form the output from the array of Fabry-Perot resonators 502 into a 3-bit optical signal at 230.

### Input Electrical Signal Processing Examples

In some embodiments, the input analog signal can be an electrical signal, and the output from the array of resonators can be a portion of an optical signal, for example, a readout light. For example, FIG. 6A illustrates a processing system 600 that receives an input analog electrical signal 602 (e.g., voltage) as well as input light 402 (e.g., at a first wavelength, λ₁) to generate an optical signal at output 612. Similar to other embodiments described elsewhere herein, the photonic system 600 includes a splitter 122 and an array of optical resonators 606-1, 606-2, 606-3 with different resonance conditions (e.g., λ₁−δ, λ₁−2δ, and λ₁−3δ). For example, the different resonance conditions can be set by respective detuning elements 610-1, 610-2, 610-3 (e.g., non-volatile or volatile detuning, as described above). The detuning in each resonator 606 can be further modified by respective modulation elements 608-1, 608-2, 608-3. In some embodiments, the input light 402 has a constant intensity. Alternatively, the input light 402 can have a varying intensity, for example, pulses timed to correspond (e.g., coincident or at least partially overlapping in time) with electrical signal 602.

In contrast to other examples where modulation elements modify resonance conditions of resonators responsive to their interactions with optical signals, modulation elements 608 in the system 600 of FIG. 6A modify the resonance conditions of resonators 606 responsive to their interactions with electrical signal 602 input via electrical input means 604 (e.g., one or more electrical traces and/or circuits). For example, the input electrical signal 602 can be divided into three substantially equal portions that respectively interact with the modulation elements 608-1, 608-2, 608-3, which can introduce an additional phase shift to the respective resonator 606-1, 606-2, 606-3. Optical input 402 thus serves as an optical readout signal, where only one resonator 606 that has its detuning compensated by the introduced phase shift (based on the interaction of the electrical signal 602 with the modulation elements 608) will generate an output at 612. In some embodiments, one, some, or each of the modulation elements 608 can be and/or comprise a thermo-optic material that is heated by the respective portion of the electrical signal 602 (e.g., doped-silicon heaters, metal heaters, etc.). Alternatively or additionally, in some embodiments, one, some, or each of the modulation elements 608 can be and/or comprise an electro-optic material, such as but not limited to polymer electro-optic materials, organic electro-optic materials, ferroelectric devices, 2D material devices, piezoelectric devices, charge-trapping devices, P-N semiconductor devices, or P-I-N semiconductor devices. Alternatively or additionally, in some embodiments, one, some, or each of the modulation elements 608 can be and/or comprise a magneto-optic material, such as but not limited to garnets, ferromagnetic metals and alloys, semiconductors, chalcogenides, ferrites, and terbium-doped glasses.

FIG. 7A shows an example of a 3-bit photonic integrated ADC 700 according to the configuration FIG. 6A. In the illustrated example, the ADC 700 employs an array 709 of seven resonator units, 707-1, 707-2, 707-3, 707-4, 707-5, 707-6, and 707-7. Each resonator unit 707 includes a respective ring resonator 706, a nonvolatile material trimmer 708, and a modulation unit 703. Each modulation unit 703 includes a modulation element 704 interacting with part of the respective ring resonator 706 and a pair of electrical contacts 705a, 705b on opposite sides of an electrically connected to the modulation element 704. Each first electrical contact 705a of the modulation units 703 can be electrically connected (e.g., in parallel) to a first electrical trace 701a (e.g., metal trace), and each second electrical contact 705b of the modulation units 703 can be electrically connected (e.g., in parallel) to a second metal trace 701b.

ADC 700 can be configured to convert the input electrical signal 702 (e.g., a voltage pulse, V₁) into a digital output (e.g., via bits 230). A 1×7 splitter 222 splits the input optical signal (at a first wavelength, λ₁) into equal parts, which are then transmitted to respective ring resonators 706 in the array 709 with different resonance conditions (e.g., multiples of a phase constant, δ, selected based on the strength of modulation by the modulation material), for example, tuned by respective nonvolatile material trimmers 708. The modulation element 704 can be provided as part of or on each ring resonator 706. The input electrical signal can be split equally between the different modulation elements 704 (e.g., using a parallel connection), and interaction of the electrical signal with the modulation elements 704 can further alter the resonance conditions of the ring resonator (e.g., generate a further phase shift) based on the power (e.g., voltage magnitude) of the input electrical signal. Only the drop port of the ring resonator 706 whose dephasing is compensated and aligns with λ₁ will be activated, thereby allowing the optical signal to propagate to the routing network 228 to form the output from the array 709 of ring resonators 706 into the desired 3-bit optical signal at 230. Optionally, the optical signal at 230 can be converted into one or more electrical signals (e.g., via detection by a photodetector) and/or multiplexed into a single output (e.g., using temporal multiplexer), in a manner similar to that described elsewhere herein.

Although FIGS. 6A and 7A shown only 2-bit and 3-bit configurations, larger number of bits can be achieved by providing a corresponding number of resonators and modulation elements, as well as appropriate selection of detuning phase constant and design of the photonic routing network, for example, such that N=2ⁿ−1. Alternatively, in some embodiments, the routing circuit can be configured such that the fewer resonators are used to achieve a desired n-bit output, for example, such that N=2ⁿ−1, as shown for the 4-bit photonic ADC 720 in FIG. 7B. Similar to FIG. 7B, ADC 720 employs a splitter 722 to split the input optical signal into equal portions that are then transmitted via respective waveguides for interaction with respective ring resonators. However, in contrast to FIG. 7B, ADC 720 includes auxiliary resonator unit 723 (with corresponding detuned resonance of λ₁−8·δ) in addition to the array of resonator units 707-1 through 707-7. The auxiliary resonator unit 723 can be dedicated to the most significant bit (MSB) (e.g., corresponding to 2³), while the other resonator units 707-1 through 707-7 can encode the lower 7 power levels (e.g., binary 000 to 111) using the resonance condition at M. Upon reaching the eighth (8^{th}) quantization level, the auxiliary resonator unit 723 can become resonant with M, thereby activating the MSB output at 724. In some embodiments, the encoded power levels at 230 may optionally be combined together via combiner 725 and provided as a single output 726, separate from the MSB output.

In some embodiments, auxiliary resonator unit 723 can include and/or be integrated with another nonvolatile memory element, for example, such that the resonator ring of the auxiliary unit 723 can retain its state beyond the activation threshold. The free spectral range (FSR) and resonance detuning δ of the ring resonators can be constructed and/or controlled such that, after MSB activation, the system resets: the resonators re-enter resonance with λ₁ at the subsequent FSR interval, enabling periodic encoding of higher-order input levels while maintaining spectral consistency.

In the illustrated example of FIG. 6A, the processing system is configured with a parallel input arrangement, where each resonator receives an equal portion of the input light 402 at substantially the same time. Alternatively, in some embodiments, the processing system can be configured with a series input arrangement 622, for example, as shown by processing system 620 in FIG. 6B. In the illustrated example of FIG. 6B, the input light 402 is transmitted along an input waveguide 623, and portions of the light are respectively conveyed to the resonators 606 by successive coupling regions 624a-c (e.g., via evanescent coupling), for example, such that resonator 606-3 receives a first portion of light 402 at a first time via coupling region 624a, resonator 606-2 receives a second portion of light 402 (minus the first portion) at a later second time via coupling region 624b, and resonator 606-1 receives a third portion of light 402 (minus the first and second portions) at an even later third time via coupling region 624c. In some embodiments, the first through third portions conveyed to the respective resonators 606 can be the same (e.g., substantially equal intensity) or different (e.g., different intensities). Detection of the output at 612 may take into account the series input arrangement, for example, by timing detection to correspond to the input timing and/or integrating detected output over a time window. Although FIG. 6B illustrates a particular configuration for the series input arrangement, embodiments of the disclosed subject matter are not limited thereto. Rather, different configurations are also possible, such as implementation of all or part of the input circuit in free space optics (e.g., using a series of plate or cube beam splitters) and/or transmission to the resonators via different coupling mechanisms (e.g., using a series of fiber-based splitters).

FIG. 7C shows an example of a 2-bit photonic integrated ADC 730 according to the configuration FIG. 6B. In the illustrated example, the ADC 730 employs an array of three resonator units, 707-1, 707-2, and 707-3. Each resonator unit 707 includes a respective ring resonator 706, a nonvolatile material trimmer 708, and a modulation unit 703. Each modulation unit 703 includes a modulation element interacting with part of the respective ring resonator 706 and a pair of electrical contacts on opposite sides of an electrically connected to the modulation element. Each first electrical contact of the modulation units 703 can be electrically connected (e.g., in parallel) to a first electrical trace 701a, and each second electrical contact of the modulation units 703 can be electrically connected to a second metal trace 701b.

In the illustrated configuration of FIG. 7C, the array of resonator units 707-1 through 707-3 has a cascaded (series) arrangement, where the input light is provided to each resonator unit in sequence via input waveguide 732. In this configuration, the optical power incident on each successive ring resonator can be modulated by the transmission characteristics of the preceding ring resonators, which may offer an advantage in some embodiments. For example, the cumulative attenuation can enhance the extinction ratio at the output of each photodetector (e.g., at bit outputs 203a, 203b, or at output 736 via combiner 734), which may improve the signal-to-noise discrimination and/or enable more reliable digital state differentiation.

### Fabricated Examples and Experimental Results

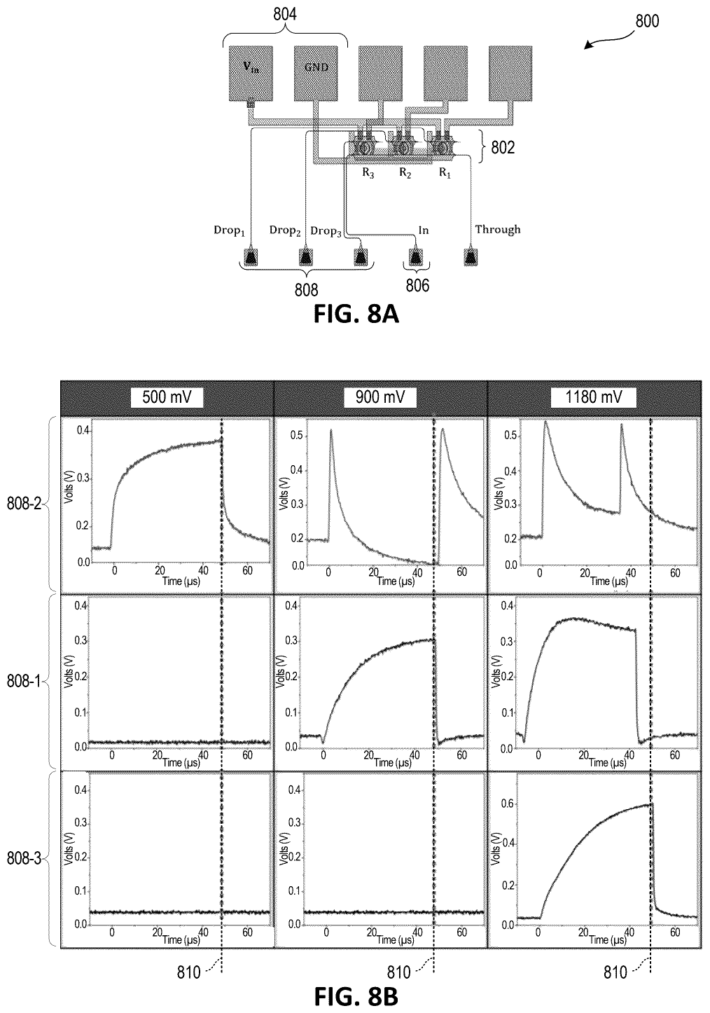

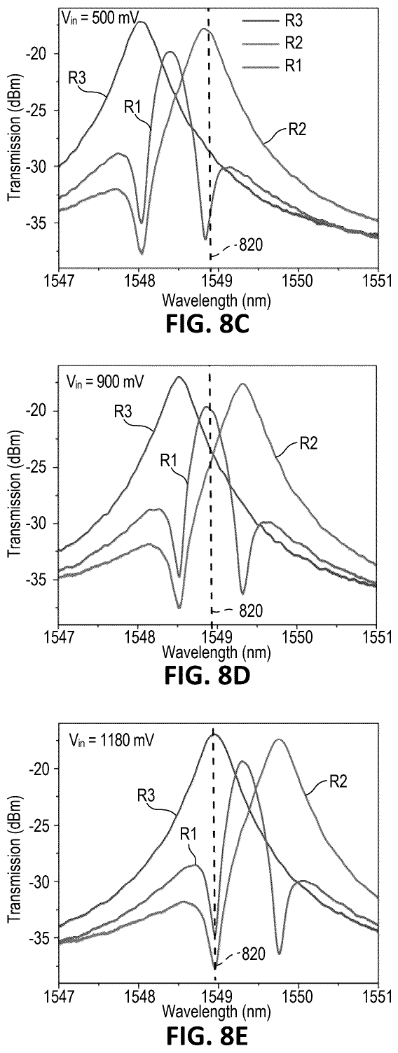

FIG. 8A shows the layout of a fabricated optoelectronic 2-bit ADC device 800, whose configuration mirrors that described in FIG. 7C. The device incorporates an array 802 of three ring resonators (R1, R2, R3). An input electrical signal (e.g., a 50-μs pulse with discrete magnitudes of 500-mV, 900-mV, or 1180-mV) was applied via bond pads 804. Readout light (e.g., at a wavelength of ˜1549-nm) was supplied to the resonator array 802 via input 806. Responsive to the magnitude of the input voltage, only one of the resonators was selectively brought into resonance, thereby routing a portion of the readout light to its associated drop port as device output 808. This operational principle is reflected in the experimental results illustrated in FIGS. 8B-8E.

As shown in FIGS. 8B-8C, an input electrical signal having a small magnitude (e.g., ˜500-mV) activated the drop port of the second ring resonator R2, such that the second drop port output 808-2 had a peak magnitude coinciding with an end 810 of the input pulse (e.g., ˜50-μs) and a spectrum that aligns with the wavelength 820 of the readout light (e.g., ˜1549-nm). As shown in FIGS. 8B and 8E, an input electrical signal having a large magnitude (e.g., ˜1180-mV) activated the drop port of the third ring resonator R3, such that the third drop port output 808-3 had a peak magnitude coinciding with an end 810 of the input pulse (e.g., ˜50-μs) and a spectrum that aligns with the wavelength 820 of the readout light (e.g., ˜1549-nm). As shown in FIGS. 8B and 8D, an input electrical signal having an intermediate magnitude (e.g., ˜900-mV) activated the drop port of the first ring resonator R1, such that the first drop port output 808-1 had a peak magnitude coinciding with an end 810 of the input pulse (e.g., ˜50-μs) and a spectrum that aligns with the wavelength 820 of the readout light (e.g., ˜1549-nm).

Each input voltage level results in an optical pulse synchronized with the end 810 of the input pulse at only one specific drop port, as shown in FIG. 8B. Consequently, synchronous detection by sampling the optical outputs at time 810 (or a predetermined window around time 810) provides an indication of the input pulse magnitude by identifying which channel (808-1, 808-2, or 808-3) carries the synchronized signal. Although the other resonators in the array also provide light to the output 808, such light is out of sync with the input pulse and can therefore be effectively rejected by a time-gated detection method

### Signal Processing Method Examples

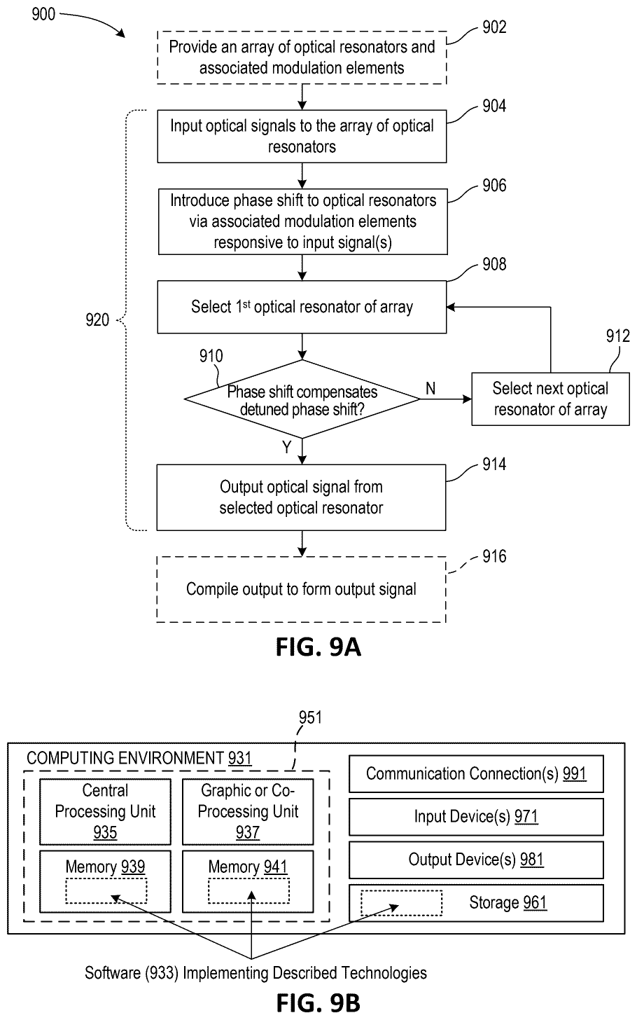

FIG. 9A shows a generalized method 900 for processing optical and/or electrical signals using optical resonators and modulation elements. The method 900 can optionally initiate at process block 902, where a processing system can be provided. For example, the processing system can include an array of optical resonators and a plurality of modulation elements. Each modulation element can be associated (e.g., coupled to and/or interacting with) with a respective one of the optical resonators. Each optical resonator can have a resonance that is detuned from at least one common wavelength (e.g., M), for example, by a different phase shift (e.g., an integer multiple of a pre-determined phase shift). In some embodiments, the providing of process block 902 can include setting the detuning, e.g., by selection and/or fabrication of an appropriate nonvolatile material trimmer and/or control of an active phase shifter.

Alternatively or additionally, the providing of process block 902 can include training the processing system, for example, to tune the modulation elements such that the processing system provides a predetermined or desired optical output in response to predetermined or desired input analog signal(s) (e.g., to serve as a neuron or part of a hidden layer in a neuromorphic computing device). In some embodiments, the provision of process block can include fabricating the optical resonators and/or modulation elements. Alternatively or additionally, the provision of process block 902 can include combining (e.g., fabricating and/or assembly) the optical resonators and/or modulation elements with one or more input optical elements (e.g., splitter, waveguides, etc.) and/or one or more output optical elements (e.g., waveguides, combiners, splitters, photodetectors, etc.). In some embodiments, the providing of process block 902 may be omitted, for example, where the processing system has already been assembled, trained, and/or is ready for use.

The method 900 can proceed to process block 904, where light can be provided to the array of optical resonators. In some embodiments, the provided light can have a parallel configuration (e.g., via a 1×N splitter), where substantially-equal portions of the light are directed to each resonator and interaction of the portions of the light with the respective resonator and/or associated modulation element occurs at substantially the same time. Alternatively, in some embodiments, the provided light can have a series configuration (e.g., via sequential evanescent coupling from a single input waveguide), where interaction of portions of the light with the respective resonator and/or associated modulation element occurs at different times. In some embodiments, the provided light, or portion thereof, can be an analog optical signal for conversion to a digital signal. Alternatively, in some embodiments, the provided light, or portion thereof, can serve as a readout light, for example, for processing of an analog electrical signal or processing of a separate optical signal. In some embodiments, the provided light can have a single wavelength (e.g., λ₁). Alternatively or additionally, the provided light can have only two wavelengths (e.g., λ₁+λ₂). In some embodiments, the provided light can have more than two wavelengths.

At process block 906, a phase shift can be introduced to each optical resonator of the array by the associated modulation element responsive to an input analog signal. For example, the magnitude of the introduced phase shift can correspond to a magnitude of the input analog signal. In some embodiments, the input analog signal can be an optical signal (e.g., at least a portion of the light provided in process block 904), and the interaction (e.g., light absorption) of the input analog signal with the modulation element can generate the introduced phase shift via a temperature change of a thermo-optic material or volatile phase transition of the modulation element. Alternatively, the input analog signal can be an electrical signal, and the interaction of the input analog signal with the modulation element can generate the introduced phase shift via a temperature change of a thermo-optic material of the modulation element (e.g., the input analog signal controls a respective electric heating element in thermal communication with the thermo-optic material) or an electro-optic material of the modulation element (e.g., the input analog signal applies an electric field to the electro-optic material). Alternatively or additionally, the modulation element can employ other nonlinear optical responses, such as Kerr nonlinearities, to generate the introduced phase shift.

At process block 908, a first optical resonator of the array can be selected, and, at decision block 910, it is determined if the detuned resonance condition of the selected optical resonator has been compensated by the introduced phase shift. If the detuned resonance condition has not been compensated, no light is output from the selected optical resonator. Alternatively or additionally, in some embodiments, light may still be output from the optical resonator even though the detuned resonance condition has not been compensated, but the timing of the output may be outside of a predetermined time window corresponding to the input signal (e.g., within +2-μs of an end of the input pulse). If the detuned resonance condition has not been compensated, the method 900 can proceed to process block 912, where the next optical resonator in the array is selected, and block 910 can be repeated for the selected optical resonator.

In contrast, if the detuned resonance condition has been compensated by the introduced phase shift, the method 900 can proceed from decision block 910 to process block 914, where an optical signal is output from the selected optical resonator. In some embodiments, the output optical signal can be output from the selected optical resonator at a time within the predetermined time window corresponding to the input signal (e.g., at the end of the input pulse). The output optical signal can be a portion of the light provided to the array in process block 904, for example, the portion of the light (or at least part of the portion) provided to the selected resonator.

In some embodiments, the optical resonator from which the optical signal is output can provide a representation or indication of the magnitude of the input analog signal. In some embodiments, this output can be further processed at optional process block 916, for example, via multiplexing (e.g., time multiplexing) and/or routing (e.g., to form a multi-bit digital representation of input signal magnitude). In some embodiments, the optical signal(s) resulting from either process block 914 or process block 916 can be detected by one or more photodetectors, for example, to convert the optical signal(s) to one or more electrical signals. In some embodiments, the detection may be synchronized with the timing of the input pulse, for example, to detect outputs from the resonator array only within the predetermined time window corresponding to the input signal.

It should be noted that the input of process block 904, the phase shift introduction of process block 906, the selections of process blocks 908 and 912, the determination of decision block 910, the outputting of process block 914, and/or the further processing of process block 916 need not be positive, manual, or active steps. Rather, any of blocks 904-916 may happen automatically and/or passively, for example, as a result of an input analog signal having a magnitude (or other characteristics) that matches conditions that allow one of the optical resonators to pass an optical signal to an output. Thus, in some embodiments, at least blocks 906-914 may be performed automatically by the processing system in response to an input analog system without any active input from a controller or user.

Although some of blocks 902-916 of method 900 have been described as being performed once, in some embodiments, multiple repetitions of a particular process block may be employed before proceeding to the next decision block or process block. In addition, although blocks 902-916 of method 900 have been separately illustrated and described, in some embodiments, process blocks may be combined and performed together (simultaneously or sequentially). Indeed, in some embodiments, at least blocks 904-914 can be part of a simultaneously-occurring process 920, where all the resonators receive input signals at the same time, process those signals at the same time, and output optical signals at the same time, rather than sequential or serial performance of said blocks.

Moreover, although FIG. 9A illustrates a particular order for blocks 902-916, embodiments of the disclosed subject matter are not limited thereto. Indeed, in certain embodiments, the blocks may occur in a different order than illustrated or simultaneously with other blocks. In some embodiments, method 900 may comprise only some of blocks 902-916 of FIG. 9A, or may include additional features and/or steps not specifically illustrated in FIG. 9A.

### Computer Implementation Examples

FIG. 9B depicts a generalized example of a suitable computing environment 931 in which the described innovations may be implemented, such as but not limited to aspects of detection of optical output (e.g., via photodetectors 128-1, 128-2), operation of and/or detection of signals from multiplexer 134, operation of and/or supply of signals to multiplexer 164, controller 144 (e.g., for detuning resonators 142-1, 142-2, 142-3 to generate a desired output in response to a particular input optical signal), method 900, etc. The computing environment 931 is not intended to suggest any limitation as to scope of use or functionality, as the innovations may be implemented in diverse general-purpose or special-purpose computing systems. For example, the computing environment 931 can be any of a variety of computing devices (e.g., desktop computer, laptop computer, server computer, tablet computer, etc.).

With reference to FIG. 9B, the computing environment 931 includes one or more processing units 935, 937 and memory 939, 941. In FIG. 9B, this basic configuration 951 is included within a dashed line. The processing units 935, 937 execute computer-executable instructions. A processing unit can be a central processing unit (CPU), processor in an application-specific integrated circuit (ASIC), or any other type of processor (e.g., hardware processors, graphics processing units (GPUs), virtual processors, etc.). In a multi-processing system, multiple processing units execute computer-executable instructions to increase processing power. For example, FIG. 9B shows a central processing unit 935 as well as a graphics processing unit or co-processing unit 937. The tangible memory 939, 941 may be volatile memory (e.g., registers, cache, RAM), non-volatile memory (e.g., ROM, EEPROM, flash memory, etc.), or some combination of the two, accessible by the processing unit(s). The memory 939, 941 stores software 933 implementing one or more innovations described herein, in the form of computer-executable instructions suitable for execution by the processing unit(s).

A computing system may have additional features. For example, the computing environment 931 includes storage 961, one or more input devices 971, one or more output devices 981, and one or more communication connections 991. An interconnection mechanism (not shown) such as a bus, controller, or network interconnects the components of the computing environment 931. Typically, operating system software (not shown) provides an operating environment for other software executing in the computing environment 931, and coordinates activities of the components of the computing environment 931.

The tangible storage 961 may be removable or non-removable, and includes magnetic disks, magnetic tapes or cassettes, CD-ROMs, DVDs, or any other medium which can be used to store information in a non-transitory way, and which can be accessed within the computing environment 931. The storage 961 can store instructions for the software 933 implementing one or more innovations described herein.

The input device(s) 971 may be a touch input device such as a keyboard, mouse, pen, or trackball, a voice input device, a scanning device, or another device that provides input to the computing environment 931. The output device(s) 981 may be a display, printer, speaker, CD-writer, or another device that provides output from computing environment 931.

The communication connection(s) 991 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, radio-frequency (RF), or another carrier.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or any other such network) using one or more network computers.

For clarity, only certain selected aspects of the software-based implementations arc described. Other details that are well known in the art are omitted. For example, it should be understood that the disclosed technology is not limited to any specific computer language or program. For instance, aspects of the disclosed technology can be implemented by software written in C++, Java™, Python®, and/or any other suitable computer language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means. In any of the above-described examples and embodiments, provision of a request (e.g., data request), indication (e.g., data signal), instruction (e.g., control signal), or any other communication between systems, components, devices, etc. can be by generation and transmission of an appropriate electrical signal by wired or wireless connections.

### Additional Examples of the Disclosed Technology

In view of the above-described implementations of the disclosed subject matter, this application discloses the additional examples in the clauses enumerated below. It should be noted that one feature of a clause in isolation, or more than one feature of the clause taken in combination, and, optionally, in combination with one or more features of one or more further clauses are further examples also falling within the disclosure of this application.

Clause 1. A system comprising:
an array of optical resonators, the resonances of the optical resonators being detuned from a first wavelength by different phase shifts;
a splitter configured to convert a first input optical signal into a plurality of second input optical signals, each second input optical signal having a substantially same intensity and being provided to a respective optical resonator of the array; and
a plurality of modulation elements, each modulation element being associated with a respective optical resonator of the array,
wherein each modulation element is constructed to introduce a phase shift to the respective optical resonator via a change in refractive index, such that one of second input optical signals is output from one of the optical resonators when the introduced phase shift compensates for the detuned phase shift of said one of the optical resonators.
   Clause 2. The system of any clause or example herein, in particular, Clause 1, wherein one, some, or all of the plurality of modulation elements comprises a thermo-optic material that introduces the phase shift based on a temperature change thereof or a material with Kerr nonlinearity that introduces the phase shift on an intensity of light passing therethrough.
   Clause 3. The system of any clause or example herein, in particular, Clause 2, wherein the thermo-optic material is constructed such that the temperature change is induced by absorption of light at a second wavelength.
   Clause 4. The system of any clause or example herein, in particular, any one of Clauses 2-3, wherein the thermo-optic material has a strong thermo-optic coefficient for light at a second wavelength, and the thermo-optic material has an extinction coefficient or imaginary refractive index for the light at the second wavelength that is nonzero.
   Clause 5. The system of any clause or example herein, in particular, Clause 4, wherein the strong thermo-optic coefficient is at least 10⁻⁴ K⁻¹.
   Clause 6. The system of any clause or example herein, in particular, any one of Clauses 2-5, wherein the thermo-optic material is or comprises Ge, Sb—Te, Ge—Sb—Se, Al—In—Sb—Te, or Ge—Sb—Te.
   Clause 7. The system of any clause or example herein, in particular, any one of Clauses 4-6, wherein the first and second wavelengths are the same, and the first input optical signal comprises light at the first wavelength.
   Clause 8. The system of any one of any clause or example herein, in particular, any one of Clauses 4-6, wherein:
the first and second wavelengths are different,
the splitter is further configured to simultaneously convert a third input optical signal into a plurality of fourth input optical signals,
each fourth input optical signal has substantially the same intensity and is provided to a respective optical resonator of the array,
the first input optical signal comprises light at the first wavelength and is configured as a readout signal, and the third input optical signal comprises light at the second wavelength.
   Clause 9. The system of any clause or example herein, in particular, Clause 2, wherein the thermo-optic material is constructed such that the temperature change is induced by electrical heating thereof.
   Clause 10. The system of any clause or example herein, in particular, Clause 9, wherein the modulation element comprises a doped-silicon heater or a metal heater.
   Clause 11. The system of any clause or example herein, in particular, any one of Clauses 1-10, wherein one, some, or all of the plurality of modulation elements comprises a volatile phase transition material that introduces the phase shift based on a temperature change thereof.
   Clause 12. The system of any clause or example herein, in particular, Clause 11, wherein the volatile phase transition material is constructed such that the temperature change causes a solid phase transition of the volatile phase transition material, thereby changing a refractive index of the volatile phase transition material.
   Clause 13. The system of any clause or example herein, in particular, any one of Clauses 11-12, wherein the volatile phase transition material comprises VO₂.
   Clause 14. The system of any clause or example herein, in particular, any one of Clauses 1-13, wherein one, some, or all of the plurality of modulation elements comprise an electro-optic material that introduces the phase shift based on an applied electric field.
   Clause 15. The system of any clause or example herein, in particular, Clause 14, wherein the electro-optic material is and/or comprises a polymer electro-optic material, an organic electro-optic material, a ferroelectric material, a 2D material, a piezoelectric material, a charge-trapping device, a P-N semiconductor device, or a P-I-N semiconductor device.
   Clause 16. The system of any clause or example herein, in particular, any one of Clauses 1-15, wherein one, some, or all of the plurality of modulation elements is disposed on or is part of a respective photonic circuit proximal to an input coupling region with the associated optical resonator.
   Clause 17. The system of any clause or example herein, in particular, any one of Clauses 1-16, wherein one, some, or all of the plurality of modulation elements is disposed on or is part of the associated optical resonator.
   Clause 18. The system of any clause or example herein, in particular, any one of Clauses 1-17, wherein one, some, or all of the optical resonators is a ring resonator.
   Clause 19. The system of any clause or example herein, in particular, any one of Clauses 1-18, wherein one, some, or all of the optical resonators is a Fabry-Perot resonator.
   Clause 20. The system of any clause or example herein, in particular, Clause 19, wherein one, some, or all of the modulation elements is disposed on or forms a part of a cavity of the associated Fabry-Perot resonator.
   Clause 21. The system of any clause or example herein, in particular, any one of Clauses 19-20, wherein one, some, or all of the modulation elements is forms a part of a reflector of the associated Fabry-Perot resonator.
   Clause 22. The system of any clause or example herein, in particular, any one of Clauses 19-21, wherein:
the first input optical signal comprises light at the first wavelength and is configured as a readout signal,
the splitter is further configured to simultaneously convert a third input optical signal into a plurality of fourth input optical signals, the third input optical signal comprising light at a second wavelength different than the first wavelength,
each fourth input optical signal has a substantially same intensity and is provided to a respective optical resonator of the array, and
one, some, or all of the modulation elements are constructed to introduce the phase shift to the respective optical resonator based on interaction with the corresponding fourth input optical.
   Clause 23. The system of any clause or example herein, in particular, any one of Clauses 1-22, wherein the optical resonators are detuned from the first wavelength by a respective integer multiple of a predetermined phase.
   Clause 24. The system of any clause or example herein, in particular, Clause 23, further comprising an output optical circuit constructed to provide a digital output corresponding to the first input optical signal, and the system is constructed as an analog-to-digital converter.
   Clause 25. The system of any clause or example herein, in particular, Clause 24, wherein the output optical circuit comprises one or more power splitters, one or more escalators, one or more waveguide crossings, or any combination of the foregoing.
   Clause 26. The system of any clause or example herein, in particular, any one of Clauses 24-25, wherein the digital output comprises an n-bit signal, and a number of the optical resonators is 2ⁿ−1, 2ⁿ, n, or 2ⁿ⁻¹.
   Clause 27. The system of any clause or example herein, in particular, any one of Clauses 24-26, further comprising an optical delay line configured to convert separate bits of the digital output into a single signal with each bit temporally separated.
   Clause 28. The system of any clause or example herein, in particular, any one of Clauses 1-27, further comprising one or more photodetectors configured to detect the one of the second input optical signals output from the array of optical resonators.
   Clause 29. The system of any clause or example herein, in particular, any one of Clauses 1-28, wherein the different phase shifts of the optical resonators are provided by a phase change material, ion implantation, a polymer, a ferroelectric material, a thermo-optic material, an electro-optic material, a magneto-optic material, a liquid crystal, or any combination of the foregoing.
   Clause 30. The system of any clause or example herein, in particular, any one of Clauses 1-22, wherein each modulation element and associated optical resonator is configured as part of a neuromorphic computing system.
   Clause 31. A system comprising at least two systems of any of any clause or example herein, in particular, any one of Clauses 1-30, arranged in an array and/or interconnected together.
   Clause 32. The system of any clause or example herein, in particular, any one of Clauses 1-31, implemented in one or more photonic devices, one or more optical fiber networks, and/or one or more free space optical setups.
   Clause 33. A method of converting an analog optical input signal to a digital optical output signal or a digital electrical output signal using the system of any clause or example herein, in particular, any one of Clauses 1-32.
   Clause 34. A method of converting an analog electrical input signal to a digital optical output signal or a digital electrical output signal using the system of any clause or example herein, in particular, any one of Clauses 1-32.
   Clause 35. A method of generating an electrical or optical output signal responsive to an analog optical input signal or an analog electrical input signal that satisfies one or more criteria using the system any clause or example herein, in particular, any one of Clauses 1-32.
   Clause 37. A neuromorphic computing method using the system any clause or example herein, in particular, any one of Clauses 1-32.
   Clause 38. A method of tuning the system any clause or example herein, in particular, any one of Clauses 1-32, to generate an electrical or optical output signal responsive to an analog optical input signal or analog electrical input signal satisfying one or more criteria.

### CONCLUSION

Although particular optical components and configuration have been illustrated in the figures and discussed in detail herein, embodiments of the disclosed subject matter are not limited thereto. Indeed, one of ordinary skill in the art will readily appreciate that different optical components or configurations can be selected and/or optical components added to provide the same effect. In practical implementations, embodiments may include additional optical components, fewer optical components, or other components or variations beyond those specifically illustrated, for example, a substrate in which the different elements of a photonic integrated circuit can be fabricated. Accordingly, embodiments of the disclosed subject matter are not limited to the particular configurations specifically illustrated and described herein.

Any of the features illustrated or described herein, for example, with respect to FIGS. 1A-9B and/or Clauses 1-38, can be combined with any other feature illustrated or described herein, for example, with respect to FIGS. 1A-9B and/or Clauses 1-38, to provide configurations, systems, devices, structures, methods, aspects, or embodiments not otherwise illustrated or specifically described herein. All features described herein are independent of one another and, except where structurally impossible, can be used in combination with any other feature described herein. In view of the many possible aspects to which the principles of the disclosed technology may be applied, it should be recognized that the illustrated features are only examples and should not be taken as limiting the scope of the disclosed technology. Rather, the scope is defined by the following claims. Applicants therefore claim all that comes within the scope and spirit of these claims.

1. A system comprising:
an array of optical resonators, resonances of the optical resonators being detuned from a first wavelength by different phase shifts, each optical resonator being constructed to receive a respective first input optical signal; and
a plurality of modulation elements, each modulation element being associated with a respective optical resonator of the array, each modulation element being constructed to introduce a phase shift to the respective optical resonator such that the respective first input optical signal is output from the array in response to the introduced phase shift compensating for the detuned phase shift of the respective optical resonator.

2. The system of claim 1, further comprising:
input optical means configured to convert an initial input optical signal into separate portions,
wherein the optical resonators are arranged in parallel with respect to the input optical means such that each optical resonator simultaneously receives a respective one of the separate portions, and
the received portion serves as the respective first input optical signal.

3. The system of claim 2, wherein the input optical means comprises a splitter configured to convert the initial input optical signal into the separate portions of substantially equal intensity.

4. The system of claim 1, further comprising:
input optical means configured to transmit an initial input optical signal,
wherein the optical resonators are arranged in series with respect to the input optical means such that each optical resonator sequentially receives a respective portion of the initial input optical signal, and
the received portion serves as the respective first input optical signal.

5. The system of claim 1, wherein at least one of the plurality of modulation elements comprises a thermo-optic material that introduces the phase shift based on a temperature change thereof.

6. The system of claim 5, wherein:
the thermo-optic material is constructed such that the temperature change is induced by absorption of light,
the thermo-optic material has a thermo-optic coefficient for the absorbed light that is at least 10⁻⁴ K⁻¹, and
the thermo-optic material has an extinction coefficient or imaginary refractive index for the absorbed light that is nonzero.

7. The system of claim 5, wherein the thermo-optic material comprises Ge, Sb—Te, Ge—Sb—Se, Al—In—Sb—Te, or Ge—Sb—Te.

8. The system of claim 1, wherein:
at least one of the plurality of modulation elements comprises a thermo-optic material and an electrical heater,
the thermo-optic material introduces the phase shift based on a temperature change thereof, and
the thermo-optic material is constructed such that the temperature change is induced by heating using the electrical heater.

9. The system of claim 1, wherein:
at least one of the plurality of modulation elements comprises a volatile phase transition material that introduces the phase shift based on a temperature change thereof, and
the volatile phase transition material is constructed such that the temperature change causes a solid phase transition of the volatile phase transition material, thereby changing a refractive index of the volatile phase transition material.

10. The system of claim 9, wherein the volatile phase transition material comprises VO₂.

11. The system of claim 1, wherein:
at least one of the plurality of modulation elements comprises an electro-optic material that introduces the phase shift based on an applied electric field or a magneto-optic material that introduces the phase shift based on an applied magnetic field.

12. The system of claim 1, wherein at least one of the plurality of modulation elements is disposed on or is part of the associated optical resonator or a respective photonic circuit proximal to an input coupling region with the associated optical resonator.

13. The system of claim 1, wherein at least one of the optical resonators is a ring resonator.

14. The system of claim 1, wherein:
at least one of the optical resonators is a Fabry-Perot resonator, and
at least one of the plurality of modulation elements forms a part of a reflector of the associated Fabry-Perot resonator, or is disposed on or forms a part of a cavity of the associated Fabry-Perot resonator.

15. The system of claim 1, further comprising:
an output optical circuit constructed to convert the output from the array into a digital representation,
wherein the optical resonators are detuned from the first wavelength by a respective integer multiple of a predetermined phase constant, and
the system is configured as an analog-to-digital converter.

16. The system of claim 1, wherein the different phase shifts of the optical resonators are provided by a phase change material, ion implantation, a polymer, a ferroelectric material, a thermo-optic material, an electro-optic material, a magneto-optic material, a liquid crystal, a Kerr nonlinearity, or any combination of the foregoing.

17. A method comprising:
providing an array of optical resonators and a plurality of modulation elements, resonances of the optical resonators being detuned from a first wavelength by different phase shifts, each modulation element being associated with a respective optical resonator of the array;
providing a plurality of first input optical signals to the array of optical resonators, respectively;
introducing, for each optical resonator, a respective phase shift via the associated modulation element; and
outputting, from the array at a predetermined time with respect to the providing the plurality of first input optical signals, the respective first input optical signal in response to the introduced phase shift compensating for the detuned phase shift of the respective optical resonator.

18. The method of claim 17, wherein the providing the plurality of first input optical signals to the array comprises:
converting an initial input optical signal into separate portions; and
providing, in parallel, the separate portions as the first input optical signals to the optical resonators, respectively.

19. The method of claim 17, wherein the providing the plurality of first input optical signals to the array comprises:
sequentially providing respective portions of an initial optical signal as the first input optical signals to the optical resonators, respectively.

20. The method of claim 17, further comprising:
converting the output from the array into a digital representation,
wherein the optical resonators are detuned from the first wavelength by a respective integer multiple of a predetermined phase.
